(19) United States
(12) Patent Application Publication
(10) Pub. No.: US 2005/0213875 A1
(43) Pub. Date: Sep. 29, 2005

(54) Optical cross-connect device and method of optical communication control

(75) Inventors: Kiichi Sugitani, Kawasaki (JP); Satoshi Kuroyanagi, Inagi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/137,365

(22) Filed: May 26, 2005

Related U.S. Application Data
(63) Continuation of application No. PCT/JP03/03179, filed on Mar. 17, 2003.

(51) Int. Cl. H04J 14/00; G03B 17/00

(52) U.S. Cl. 385/16

(57) ABSTRACT

An optical cross-connect device, which has a presently-used optical cross-connect section and a preliminary optical cross-connect section, includes a switching unit. When a transmission path from a transmission node to a reception node is operating under normal conditions, the switching unit switches priority signals from the presently-used optical fiber at an input side from inside, outputs the priority signals to the presently-used optical fiber at an output side to the inside, switches the non-priority signals from the preliminary optical fiber at the input side from the inside, and outputs the non-priority signals to the preliminary optical fiber at the output side to the inside. When the transmission path is in trouble, the switching unit switches the priority signals from the preliminary optical fiber at the input side from the inside, and outputs the priority signals to the preliminary optical fiber at the output side to the inside.

### CROSS-REFERENCE TO RELATED APPLICATION

This application is a U.S. continuation application filed under 35 USC 111(a) claiming benefit under 35 USC 120 and 365(c) of PCT application JP03/03179, filed Mar. 17, 2003. The application is hereby incorporated herein by reference.

### TECHNICAL FIELD

The present invention relates to an optical cross-connect device provided in an optical network constituted by optical fibers for transmitting priority signals and non-priority signals having different priority levels from a transmission node to a reception node, and a method of optical communication control using the optical cross-connect device.

### TECHNICAL BACKGROUND

Along with growing capacity and speed of communication, it is required that networks and transmission systems operate in broad bands and have large capacities. To attain this object, it is desired that an optical network be constructed based on a wavelength division multiplexing (WDM) technique. As an optical cross-connect device is a device for de-multiplexing wavelength-multiplexed optical signals from plural optical fibers into wavelength components, switching the optical signals, multiplexing the optical signals again, and outputting the optical signals to a desired optical fiber, it plays an important role when constructing the optical network.

FIG. 1 is a diagram schematically exemplifying an optical network, in which when a transmission path from a transmission node to a reception node is in trouble, the transmission path as a whole is switched, and optical signals are transmitted through a new transmission path by using preliminary optical fibers.

The optical network shown in FIG. 1 includes nine optical cross-connect devices (optical XC) 1 through 9, optical fibers 11 being used presently, and preliminary optical fibers 12. The optical fibers 11 and the preliminary optical fibers 12 connect the optical cross-connect devices 1 through 9.

Under normal conditions, consider that there is an optical signal transmission from a transmission node connected to the optical XC1 to a reception node connected to the optical XC8. In this case, a transmission path including the presently-used optical fibers 11 connecting the optical XC1, optical XC2, optical XC5, and optical XC8, is set in operation.

Next, consider that there is an optical signal transmission from a transmission node connected to the optical XC2 to a reception node connected to the optical XC9. In this case, a transmission path including the presently-used optical fibers 11 connecting the optical XC2, optical XC5, optical XC8, and the optical XC9, is set in operation.

Under these conditions, suppose trouble occurs between the optical XC2 and the optical XC5. In this case, the whole transmission path including the presently-used optical fibers 11 connecting the optical XC2 and optical XC5 is switched, and after switching, the transmission path is constituted by the preliminary optical fibers 12. Specifically, the transmission path constituted by the presently-used optical fibers 11 connecting the optical XC1, optical XC2, optical XC5, and optical XC8, is switched to a transmission path including the preliminary optical fibers 12 connecting the optical XC1, optical XC4, optical XC7, and the optical XC8. Further, the transmission path constituted by the presently-used optical fibers 11 connecting the optical XC2, optical XC5, optical XC8, and the optical XC9 is switched to a transmission path including the preliminary optical fibers 12 connecting the optical XC2, optical XC3, optical XC6, and the optical XC9.

FIG. 2 and FIG. 3 are block diagrams illustrating configurations of an optical connect device used for switching the transmission path as shown in FIG. 1. In these figures, thick solid lines indicate transmission paths of optical signals.

The optical cross-connect device shown in FIG. 2 or FIG. 3 is connected to devices outside at the input side thereof through a number of k pairs of inter-station optical fibers 700-1 through 700-k, each pair of the optical fibers including a presently-used optical fiber (W) 701 and a preliminary optical fiber (P) 702, and is connected to devices inside through inner connection lines 711-1 through 711-j (collectively referred to as “inner connection lines 711” below where appropriate).

Similarly, the optical cross-connect device is connected to devices outside at the output side thereof through a number of k pairs of inter-station optical fibers 800-1 through 800-k, each pair of the optical fibers including a presently-used optical fiber (W) 801 and a preliminary optical fiber (P) 802, and is connected to devices inside through inner connection lines 811-1 through 811-j (collectively referred to as “inner connection lines 811” below where appropriate).

The optical cross-connect device includes a presently-used optical cross-connect section 510 connected with the presently-used optical fibers 701, 801, a preliminary optical cross-connect section 520 connected with the preliminary optical fibers 702, 802, optical distributors (DIS) 530-1 through 530-j (collectively referred to as “optical distributors 530” below where appropriate), and optical selectors (SEL) 550-1 through 550-j (collectively referred to as “optical selectors 550” below where appropriate).

In addition, the presently-used optical cross-connect section 510 includes optical de-multiplexers 511-1 through 511-k (collectively referred to as “optical de-multiplexers 511” below where appropriate), an optical switch 512, optical-electrical-optical (O/E/O) converters 513-1-1 through 513-k-n (collectively referred to as “O/E/O 513” below where appropriate), and optical multiplexers 514-1-1 through 514-k-n (collectively referred to as “optical multiplexers 514” below where appropriate).

Similarly, the preliminary optical cross-connect section 520 includes optical de-multiplexers 521-1 through 521-k (collectively referred to as “optical de-multiplexers 521” below where appropriate), an optical switch 522, optical-electrical-optical (O/E/O) converters 523-1-1 through 523-k-n (collectively referred to as “O/E/O 523” below where appropriate), and optical multiplexers 524-1-1 through 524-k-n (collectively referred to as “optical multiplexers 524” below where appropriate).

When the transmission path from a transmission node to a reception node is operating under normal conditions, as illustrated in FIG. 2, wavelength-multiplexed optical signals from devices outside are transmitted through the presently-used optical fiber (W) 701, and are input to the presently-used optical cross-connect section 510.

Each of the optical de-multiplexers 511-1 through 511-k in the presently-used optical cross-connect section 510 is connected to a corresponding presently-used optical fiber (W) 701. Each of the optical de-multiplexers 511 de-multiplexes wavelength-multiplexed optical signals into signal components having specific wavelengths (here, denoted as λ1 to λn), and outputs these signal components to the optical switch 512.

Optical signals from devices inside are transmitted through the inner connection lines 711, and are input to the optical distributors 530. The input terminal of each of the optical distributors (DIS) 530-1 through 530-j is connected to a corresponding inner connection line 711. The optical distributors 530 output the input optical signals to both the optical switch 512 in the presently-used optical cross-connect section 510 and the optical switch 522 in the preliminary optical cross-connect section 520.

The optical switch 512, upon receiving optical signals, switches the transmission path for the optical signals, and outputs the optical signals to the O/E/O 513 and the optical selectors 550. The O/E/O 513 converts the input optical signals into electrical signals, shapes and amplifies the signals, converts the electrical signals into optical signals again, and outputs the signals into corresponding optical multiplexers 514.

Each of the optical multiplexers 514-1 through 514-k is connected to one of the presently-used optical fibers 801. These optical multiplexers 514 multiplex the input optical signals by wavelength multiplexing, and output the resulting signals into the presently-used optical fibers 801.

The input terminal of each of the optical selectors 550-1 through 550-j is connected to the optical switch 512 and the optical switch 522, and the output terminal of each of the optical selectors 550-1 through 550-j is connected to a corresponding inner connection line 811.

In the optical selectors 550, one of the optical signals respectively input to the two input terminals is output to the inner connection line 811. Here, the optical selectors 550 receive optical signals from the optical switch 512 only, and output the optical signals to the inner connection line 811 directly.

When a transmission path from a transmission node to a reception node is in trouble, as illustrated in FIG. 3, the wavelength-multiplexed optical signals from devices outside are transmitted through the preliminary optical fiber 702, and are input to the preliminary optical cross-connect section 520. Each of the optical de-multiplexers 521-1 through 521-k in the preliminary optical cross-connect section 520 is connected to a corresponding preliminary optical fiber (W) 702. Each of the optical de-multiplexers 521 de-multiplexes wavelength-multiplexed optical signals into signal components having specific wavelengths (here, denoted as λ1 to λm), and outputs these signal components to the optical switch 522.

Optical signals from devices inside are transmitted through the inner connection lines 711, and are input to the optical distributors 530. The optical distributors 530 output the input optical signals to both the optical switch 512 in the presently-used optical cross-connect section 510 and the optical switch 522 in the preliminary optical cross-connect section 520.

The optical switch 522, upon receiving optical signals, switches the transmission path for the optical signals, and outputs the optical signals to the O/E/O 523 and the optical selectors 550. The O/E/O 523 converts the input optical signals into electrical signals, shapes and amplifies the signals, converts the electrical signals into optical signals again, and then outputs the signals into respective optical multiplexers 524.

Each of the optical multiplexers 524-1 through 524-k is connected to one of the preliminary optical fibers 802. These optical multiplexers 524 multiplex the input optical signals by wavelength multiplexing, and output the resulting signals into the preliminary optical fibers 802. The optical selectors 550 output optical signals from the optical switch 522 only to the inner connection line 811.

FIG. 4 is a diagram schematically exemplifying an optical network, in which, when a transmission path from a transmission node to a reception node is in trouble, the transmission path as a whole is switched, and optical signals are transmitted through a new transmission path in a preliminary wavelength band.

The optical network shown in FIG. 4 includes nine optical cross-connect devices (optical XC) 1 through 9, a wavelength band 21 being used presently, and a preliminary wavelength band 22. The wavelength band 21 and the preliminary wavelength band 22 connect the optical cross-connect devices 1 through 9.

Under normal conditions, consider that there is an optical signal transmission from a transmission node connected to the optical XC1 to a reception node connected to the optical XC8. In this case, a transmission path including the presently-used wavelength band 21 connecting the optical XC1, optical XC2, optical XC5, and optical XC8, is set in operation.

Next, consider that there is an optical signal transmission from a transmission node connected to the optical XC2 to a reception node connected to the optical XC9. In this case, a transmission path including the presently-used wavelength band 21 connecting the optical XC2, optical XC5, optical XC8, and the optical XC9, is set in operation.

Under these conditions, suppose trouble occurs between the optical XC2 and the optical XC5. In this case, the whole transmission path including the presently-used wavelength band 21 connecting the optical XC2 and optical XC5 is switched, and after switching, the transmission path is constituted by the preliminary wavelength band 22. Specifically, the transmission path constituted by the presently-used wavelength band 21 connecting the optical XC1, optical XC2, optical XC5, and optical XC8, is switched to a transmission path including the preliminary wavelength band 22 connecting the optical XC1, optical XC4, optical XC7, and the optical XC8. Further, the transmission path constituted by the presently-used wavelength band 21 connecting the optical XC2, optical XC5, optical XC8, and the optical XC9 is switched to a transmission path including the preliminary wavelength band 22 connecting the optical XC2, optical XC3, optical XC6, and the optical XC9.

FIG. 5 and FIG. 6 illustrate configurations of an optical connect device used for switching the transmission path as shown in FIG. 4. In these figures, thick solid lines indicate transmission paths of optical signals.

The optical cross-connect device shown in FIG. 5 or FIG. 6 is connected to devices outside at the input side thereof through inter-station optical fibers 700-1 through 700-k, and is connected to devices inside through inner connection lines 711-1 through 711-j.

Similarly, the optical cross-connect device is connected to devices outside at the output side thereof through inter-station optical fibers 800-1 through 800-k, and is connected to inner station devices through inner connection lines 811-1 through 811-j.

Compared to FIG. 2 and FIG. 3, the optical cross-connect device further includes wavelength separators 540-1 to 540-k (collectively referred to as “wavelength separators 540” below where appropriate), and optical synthesizers 560-1 to 560-k (collectively referred to as “optical synthesizers 560” below where appropriate).

When the transmission path from a transmission node to a reception node is operating under normal conditions, as illustrated in FIG. 5, wavelength-multiplexed optical signals from devices outside are transmitted through the presently-used wavelength band (W) of the inter-station optical fibers 700, and are input to the wavelength separators 540. Each of the wavelength separators 540-1 to 540-k is connected to a corresponding inter-station optical fiber 700. In response to the fact that the input optical signals are transmitted through the presently-used wavelength band, the wavelength separators 540 output the optical signals to the presently-used optical cross-connect section 510. Each of the optical de-multiplexers 511 in the presently-used optical cross-connect section 510 de-multiplexes wavelength-multiplexed optical signals into signal components having specific wavelengths (here, denoted as λ1 to λn), and outputs the signal components to the optical switch 512.

The same as FIG. 2, optical signals from devices inside are transmitted through the inner connection lines 711, and are input to the optical distributors 530. The optical distributors 530 output the input optical signals to both the optical switch 512 in the presently-used optical cross-connect section 510 and the optical switch 522 in the preliminary optical cross-connect section 520.

The optical switch 512, upon receiving optical signals, switches the transmission path for the optical signals, and outputs the optical signals to the O/E/O 513 and the optical selectors 550. The O/E/O 513 converts the input optical signals into electrical signals, shapes and amplifies the signals, converts the electrical signals into optical signals again, and outputs the signals into corresponding optical multiplexers 514. The optical multiplexers 514 multiplex the input optical signals by wavelength multiplexing, and output the resulting signals into the optical synthesizers 560.

Each of the optical synthesizers 560-1 to 560-k is connected to a corresponding inter-station optical fiber 700. The optical synthesizers 560 output the input optical signals into the presently-used wavelength band of the inter-station optical fibers 800.

The input terminal of each of the optical selectors 550-1 through 550-j is connected to the optical switch 512 and the optical switch 522, and the output terminal of each of the optical selectors 550-1 through 550-j is connected to a corresponding inner connection line 811.

In the optical selectors 550, one of the optical signals respectively input to the two input terminals is output to the inner connection line 811. Here, the optical selectors 550 receive optical signals from the optical switch 512 only, and output the optical signals to the inner connection line 811 directly.

When a transmission path from a transmission node to a reception node is in trouble, as illustrated in FIG. 6, the wavelength-multiplexed optical signals from devices outside are transmitted through the preliminary wavelength band (W) of the inter-station optical fibers 700, and are input to the wavelength separators 540. In response to the fact that the input optical signals are transmitted through the preliminary wavelength band, the wavelength separators 540 outputs the optical signals to the preliminary optical cross-connect section 520. Each of the optical de-multiplexers 521 de-multiplexes wavelength-multiplexed optical signals into signal components having specific wavelengths (here, denoted as λ1 to λm), and outputs these signal components to the optical switch 522.

Optical signals from devices inside are transmitted through the inner connection lines 711, the same as FIG. 3, and are input to the optical distributors 530. The optical distributors 530 output the input optical signals to both the optical switch 512 in the presently-used optical cross-connect section 510 and the optical switch 522 in the preliminary optical cross-connect section 520.

The optical switch 522, upon receiving optical signals, switches the transmission path for the optical signals, and outputs the optical signals to the O/E/O 523 and the optical selectors 550. The O/E/O 523 converts the input optical signals into electrical signals, shapes and amplifies the signals, converts the electrical signals into optical signals again, and then outputs the signals into corresponding optical multiplexers 524. The optical multiplexers 524 multiplex the input optical signals by wavelength multiplexing, and output the resulting signals into the optical synthesizers 560.

The optical synthesizers 560 output the input optical signals into the preliminary wavelength band of the inter-station optical fibers 800.

The optical selectors 550 output the optical signals from the optical switch 512 to the inner connection line 811.

FIG. 7 is a diagram schematically exemplifying an optical network, in which, when a transmission path from a transmission node to a reception node is in trouble, a section of the transmission path including the trouble spot is switched to an alternate path, and optical signals are transmitted through a preliminary fiber in the alternate path.

The optical network shown in FIG. 7 includes nine optical cross-connect devices (optical XC) 1 through 9, and optical fibers 11 being used presently and preliminary optical fibers 12, which connect the optical cross-connect devices 1 through 9.

Under normal conditions, consider that there is an optical signal transmission from a transmission node connected to the optical XC1 to a reception node connected to the optical XC8. In this case, a transmission path including the presently-used optical fibers 11 connecting the optical XC1, optical XC2, optical XC5, and optical XC8, is set in operation.

Next, consider that there is an optical signal transmission from a transmission node connected to the optical XC2 to a reception node connected to the optical XC9. In this case, a transmission path including the presently-used optical fibers 11 connecting the optical XC2, optical XC5, optical XC8, and the optical XC9, is set in operation.

Under these conditions, suppose trouble occurs between the optical XC2 and the optical XC5. In this case, the transmission path including the presently-used optical fibers 11 connecting the optical XC2 and optical XC5 is switched to the alternate path, and the alternate path is constituted by the preliminary optical fibers 12. Specifically, in the transmission path constituted by the presently-used optical fibers 11 connecting the optical XC1, optical XC2, optical XC5, and optical XC8, a section from the optical XC2 to the optical XC5 including the trouble spot is switched to the alternate path including the preliminary optical fibers 12 connecting the optical XC2, optical XC3, optical XC6, and the optical XC5. Further, in the transmission path constituted by the presently-used optical fibers 11 connecting the optical XC2, optical XC5, optical XC8, and the optical XC9, the section from the optical XC2 to the optical XC5 including the trouble spot is switched to an alternate path including the preliminary optical fibers 12 connecting the optical XC2, optical XC3, optical XC6, and the optical XC5.

FIG. 8 and FIG. 9 illustrate configurations of an optical cross-connect device used for switching the transmission path as shown in FIG. 7. In these figures, thick solid lines indicate transmission paths of optical signals.

The optical cross-connect device shown in FIG. 8 or FIG. 9 is connected to devices outside at the input side thereof through a number of k pairs of inter-station optical fibers 700-1 through 700-k, each pair of the optical fibers including a presently-used optical fiber 701 and a preliminary optical fiber 702, and is connected to devices inside through inner connection lines 711-1 through 711-j.

Similarly, the optical cross-connect device is connected to devices outside at the output side thereof through a number of k pairs of inter-station optical fibers 800-1 through 800-k, each pair of the optical fibers including a presently-used optical fiber 801 and a preliminary optical fiber 802, and is connected to devices inside through inner connection lines 811-1 through 811-j.

The optical cross-connect device includes a presently-used optical cross-connect section 510, a preliminary optical cross-connect section 520, optical selectors (SEL) 541-1 through 541-k (collectively referred to as “optical selectors 541” below where appropriate), and optical selectors (SW) 551-1 through 551-k (collectively referred to as “optical selectors 551” below where appropriate).

Among the above components, the presently-used optical cross-connect section 510 has the same configuration as the presently-used optical cross-connect section 510 in FIG. 2.

The preliminary optical cross-connect section 520 includes optical switches 525, 529, optical de-multiplexers 526-1 through 526-r, optical-electrical-optical (O/E/o) converters 527-1-1 through 527-r-m (collectively referred to as “O/E/O 527” below where appropriate), and optical multiplexers 528-1-1 through 528-r-m (collectively referred to as “optical multiplexers 528” below where appropriate).

When the transmission path from a transmission node to a reception node is operating under normal conditions, as illustrated in FIG. 8, wavelength-multiplexed optical signals from devices outside are transmitted through the presently-used optical fiber 701, and are input to the optical selectors 541. Each of the optical selectors 541-1 through 541-k is connected to a corresponding presently-used optical fiber 701. The optical selectors 541 output optical signals from the presently-used optical fibers 701 to the presently-used optical cross-connect section 510.

Each of the optical de-multiplexers 511-1 through 511-k in the presently-used optical cross-connect section 510 is connected to a corresponding optical selector 541. Each of the optical de-multiplexers 511 de-multiplexes wavelength-multiplexed optical signals into signal components having specific wavelengths (here, denoted as λ1 to λn), and outputs these signal components to the optical switch 512.

Optical signals from devices inside are transmitted through the inner connection lines 711, and are input to the optical switch 512 in the presently-used optical cross-connect section 510.

The optical switch 512, upon receiving optical signals, switches the transmission path for the optical signals, and outputs the optical signals to the O/E/O 513. The O/E/O 513 converts the input optical signals into electrical signals, shapes and amplifies the signals, converts the electrical signals into optical signals again, and outputs the signals into respective optical multiplexers 514.

The optical multiplexers 514 multiplex the input optical signals by wavelength multiplexing, and output the resulting signals into the optical selectors 551.

Each of the optical selectors 551-1 through 551-k is connected to one of the presently-used optical fibers 801. These optical selectors 551 output the optical signals into the presently-used optical fibers 801.

On the other hand, when trouble occurs in a transmission path from a transmission node to a reception node, as illustrated in FIG. 9, optical signals transmitted through the preliminary optical fiber 702 from devices outside are input to the preliminary optical cross-connect section 520.

The optical switch 525 in the preliminary optical cross-connect section 520, upon receiving optical signals, switches the transmission path for the optical signals. When the output destination of the optical signals is the presently-used optical fibers 801 or the inner connection lines 811, the optical signals are output to the optical selectors 541. When the output destination of the optical signals is the preliminary optical fibers 802, the optical signals are output to the optical de-multiplexers 526.

The optical de-multiplexers 526 de-multiplex the wavelength-multiplexed optical signals into signal components having specific wavelengths (here, denoted as λ1 to λm), and outputs these signal components to the O/E/O 527.

The O/E/O 527 converts the input optical signals into electrical signals, shapes and amplifies the signals, converts the electrical signals into optical signals again, and outputs the signals into corresponding optical multiplexers 528.

The optical multiplexers 528 multiplex the input optical signals by wavelength multiplexing, and output the resulting signals into the optical switch 529.

The optical switch 529, upon receiving optical signals, switches the transmission path for the optical signals, and outputs the optical signals to the preliminary optical fibers 802.

When the optical switch 525 outputs the optical signals to the optical selectors 541, the optical selectors 541 output the optical signals to the presently-used optical cross-connect section 510.

The optical de-multiplexers 511 de-multiplex wavelength-multiplexed optical signals into signal components having specific wavelengths, and outputs the signal components to the optical switch 512.

Optical signals from devices inside are transmitted through the inner connection lines 711, and are input to the optical switch 512 in the presently-used optical cross-connect section 510.

The optical switch 512, upon receiving optical signals, switches the transmission path for the optical signals, and outputs the optical signals to the O/E/O 513 or to the inner connection line 811. The O/E/O 513 converts the input optical signals into electrical signals, shapes and amplifies the signals, converts the electrical signals into optical signals again, and outputs the signals into corresponding optical multiplexers 514.

The optical multiplexers 514 multiplex the input optical signals by wavelength multiplexing, and output the resulting signals into the optical selectors 551.

The optical selectors 551 output the optical signals into the presently-used optical fibers 801 or the optical switch 529 in the preliminary optical cross-connect section 520.

The optical switch 529, upon receiving optical signals, switches the transmission path for the optical signals, and outputs the optical signals to the preliminary optical fibers 802.

For example, Japanese Laid Open Patent Application No. 7-86988 is related to the above-mentioned optical cross-connect devices.

However, for example, if the optical signals are classified, depending on necessity of real-time processing, into signals that ought to be transmitted preferentially (priority signals) and signals that need not be transmitted preferentially (non-priority signals), communication control for transmitting the priority signals in preference to the non-priority signals is not taken into consideration in the above-mentioned optical cross-connect devices.

### DISCLOSURE OF THE INVENTION

A general object of the present invention is to provide an optical cross-connect device and an optical communication control method enabling communication control corresponding to transmission priority to solve one or more problems of the related art.

A specific object of the present invention is to provide an optical cross-connect device and an optical communication control method able to preferentially transmit signals of higher transmission priority when trouble occurs in a transmission path.

According to an aspect of the present invention, there is provided an optical cross-connect device in an optical network that is constituted by a pair of a presently-used optical fiber and a preliminary optical fiber to transmit priority signals and non-priority signals having different priority levels from a transmission node to a reception node, said optical cross-connect device comprising a switching unit that, when a transmission path from a transmission node to a reception node is operating under normal conditions, switches the priority signals from the presently-used optical fiber at an input side and from inside, and outputs the priority signals to the presently-used optical fiber at an output side and to the inside, and switches the non-priority signals from the preliminary optical fiber at the input side and from the inside, and outputs the non-priority signals to the preliminary optical fiber at the output side and to the inside, and when the transmission path from the transmission node to the reception node is in trouble, switches the priority signals from the preliminary optical fiber at the input side and from the inside, and outputs the priority signals to the preliminary optical fiber at the output side and to the inside.

According to the above optical cross-connect device, when the transmission path is operating under normal conditions, not only the priority signals but also the non-priority signals are switched and transmitted, enabling efficient utilization of bandwidth. On the other hand, when the transmission path is in trouble, only the priority signals are switched and transmitted, hence, the priority signals can be preferentially transmitted even though the bandwidth is reduced due to the trouble.

### BRIEF DESCRIPTION OF THE DRAWINGS

These and other objects, features, and advantages of the present invention will become more apparent with reference to the following drawings accompanying the detailed description of the present invention.

FIG. 1 is a diagram schematically illustrating a first example of an optical network in the related art;

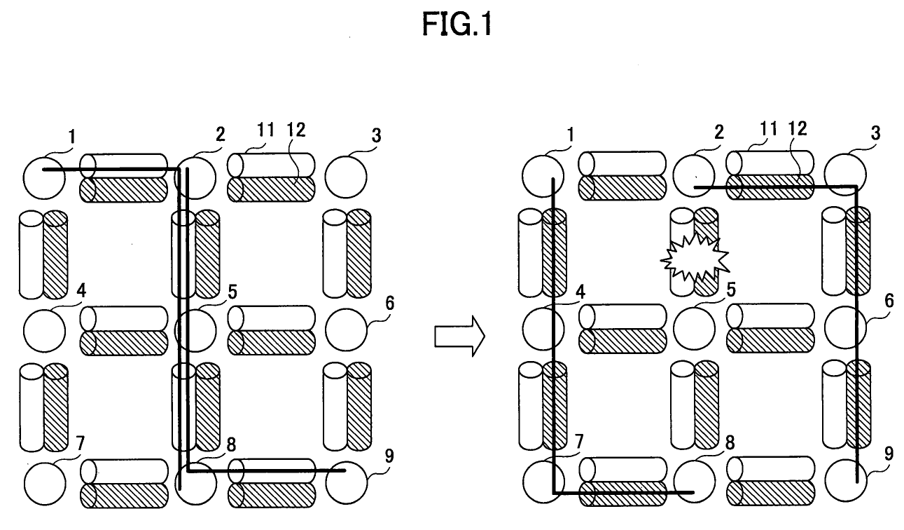

FIG. 2 is a block diagram illustrating an example of a configuration of the optical connect device in FIG. 1 under normal conditions;

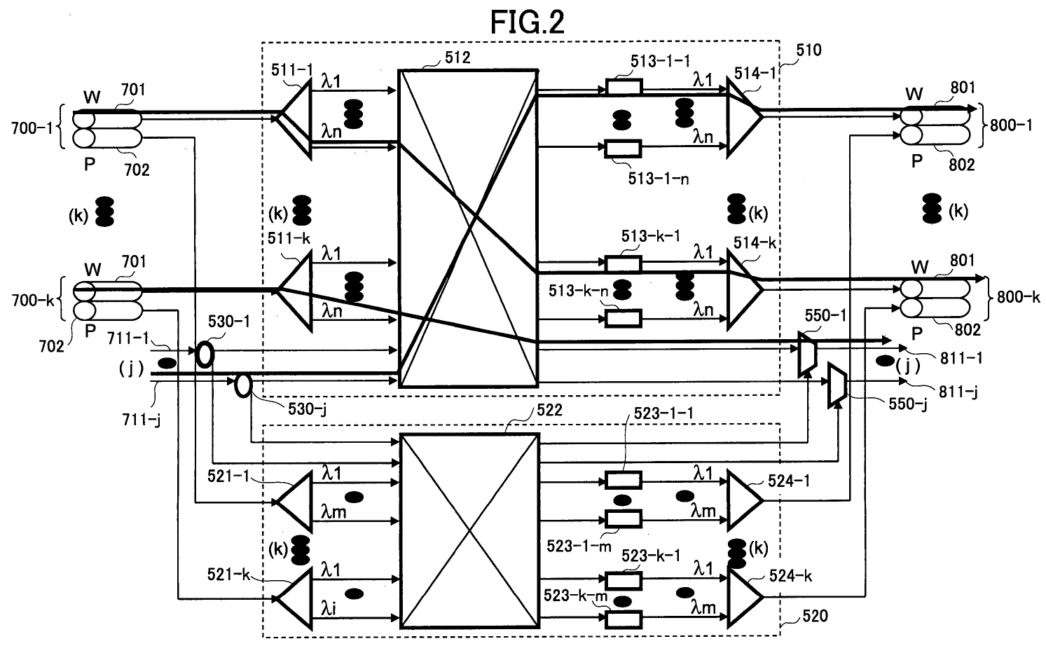

FIG. 3 is a block diagram illustrating an example of a configuration of the optical connect device in FIG. 1 when trouble occurs;

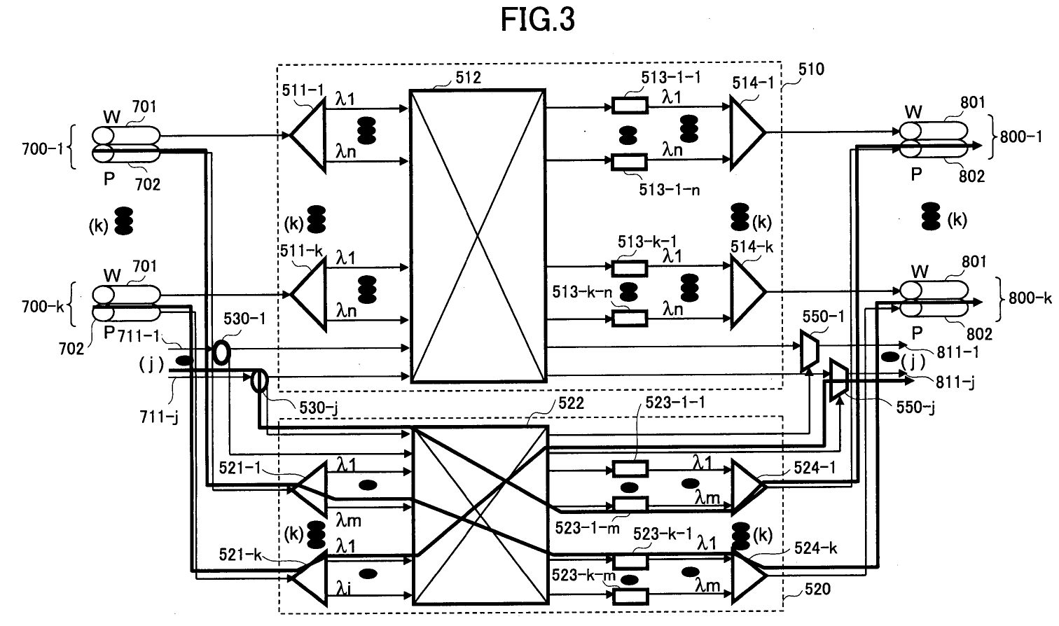

FIG. 4 is a diagram schematically illustrating a second example of an optical network in the related art;

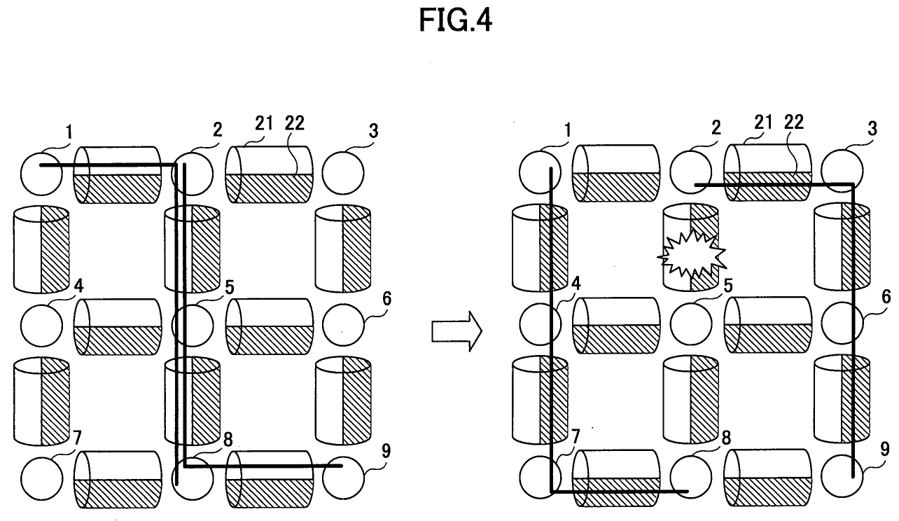

FIG. 5 is a block diagram illustrating an example of a configuration of the optical connect device in FIG. 4 under normal conditions;

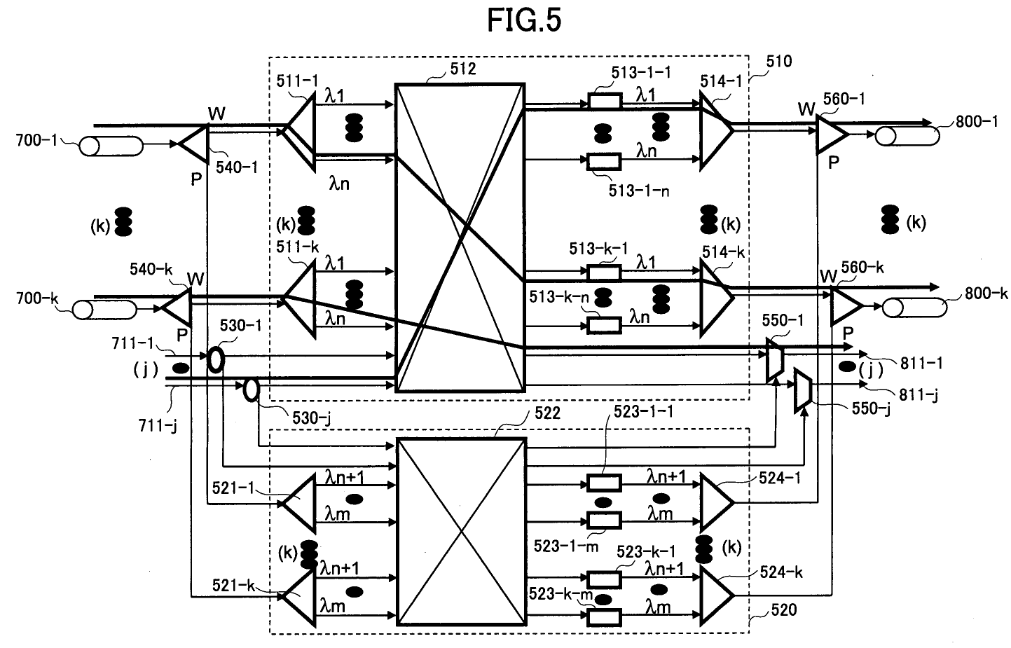

FIG. 6 is a block diagram illustrating an example of a configuration of the optical connect device in FIG. 4 when trouble occurs;

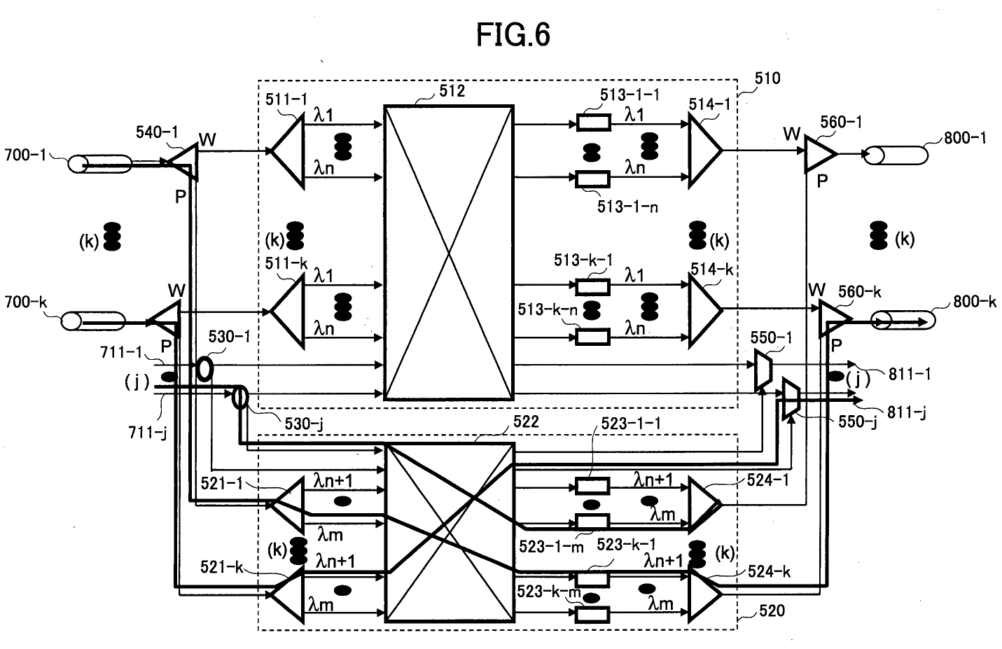

FIG. 7 is a diagram schematically illustrating a third example of an optical network in the related art;

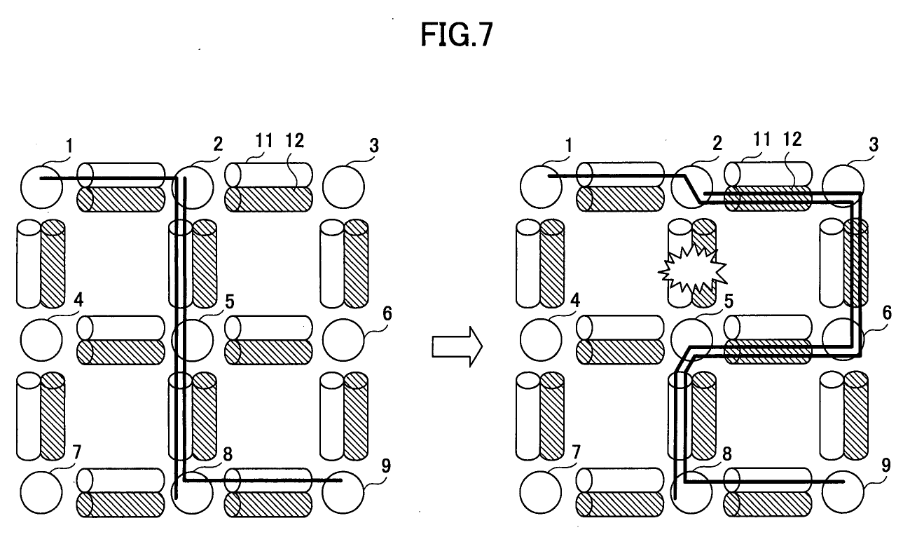

FIG. 8 is a block diagram illustrating an example of a configuration of the optical connect device in FIG. 7 under normal conditions;

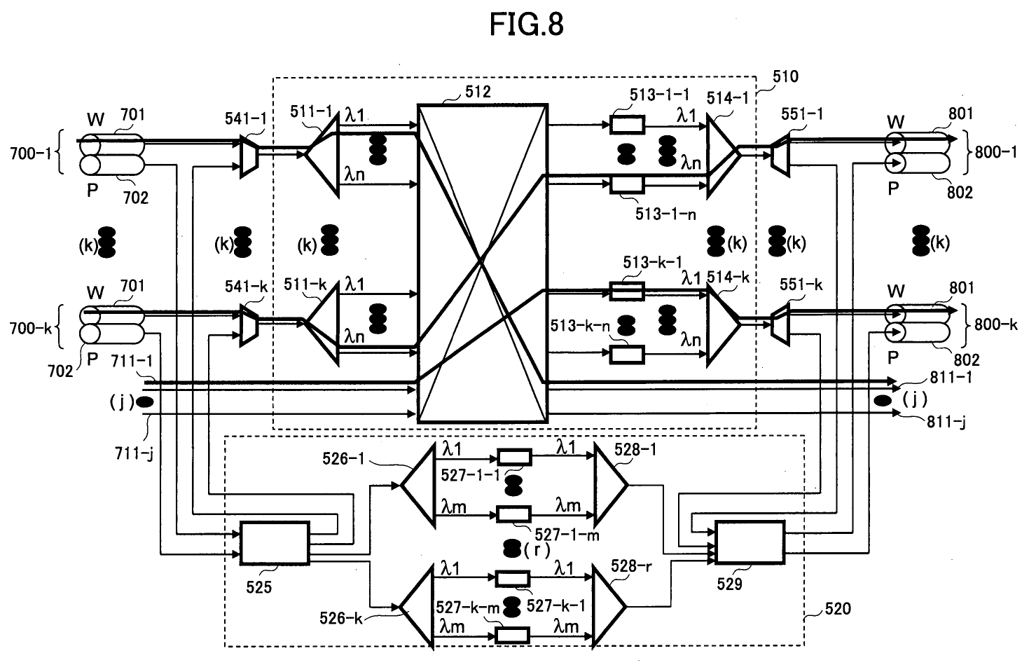

FIG. 9 is a block diagram illustrating an example of a configuration of the optical connect device in FIG. 7 when trouble occurs;

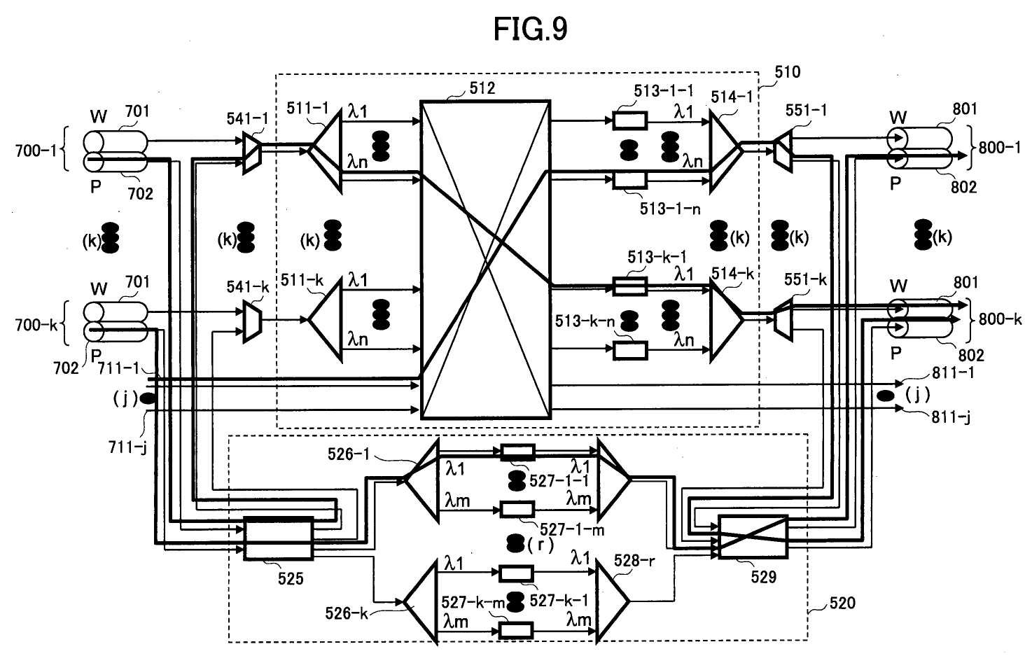

FIG. 10 is a diagram schematically illustrating an optical network according to a first embodiment;

FIG. 11 is a block diagram illustrating an example of a configuration of the optical connect device in FIG. 10 under normal conditions;

FIG. 12 is a block diagram illustrating an example of a configuration of the optical connect device in FIG. 10 when trouble occurs;

FIG. 13 is a block diagram illustrating a first modification of the optical connect device in FIG. 10;

FIG. 14 is a block diagram illustrating a second modification of the optical connect device in FIG. 10;

FIG. 15 is a block diagram illustrating a third modification of the optical connect device in FIG. 10;

FIG. 16 is a diagram schematically illustrating an optical network according to a second embodiment;

FIG. 17 is a block diagram illustrating an example of a configuration of the optical connect device in FIG. 16 under normal conditions;

FIG. 18 is a block diagram illustrating an example of a configuration of the optical connect device in FIG. 16 when trouble occurs;

FIG. 19 is a block diagram illustrating a first modification of the optical connect device in FIG. 16;

FIG. 20 is a block diagram illustrating a second modification of the optical connect device in FIG. 16;

FIG. 21 is a block diagram illustrating a third modification of the optical connect device in FIG. 16;

FIG. 22 is a diagram schematically illustrating an optical network according to a third embodiment;

FIG. 23 is a block diagram illustrating an example of a configuration of the optical connect device in FIG. 22 under normal conditions;

FIG. 24 is a block diagram illustrating an example of a configuration of the optical connect device in FIG. 22 when trouble occurs;

FIG. 25 is a block diagram illustrating a first modification of the optical connect device in FIG. 22;

FIG. 26 is a block diagram illustrating a second modification of the optical connect device in FIG. 22;

FIG. 27 is a block diagram illustrating a third modification of the optical connect device in FIG. 22;

FIG. 28 is a block diagram illustrating an example of a configuration of a preliminary optical cross-connect section, a PCA outputting section, and a PCA inputting section of the optical cross-connect device as shown in FIG. 22 when trouble occurs;

FIG. 29 is a block diagram illustrating a first modification of a preliminary optical cross-connect section, a PCA outputting section, and a PCA inputting section of the optical cross-connect device as shown in FIG. 22 when trouble occurs;

FIG. 30 is a block diagram illustrating a second modification of a preliminary optical cross-connect section, a PCA outputting section, and a PCA inputting section of the optical cross-connect device as shown in FIG. 22 when trouble occurs; and

FIG. 31 is a block diagram illustrating a third modification of a preliminary optical cross-connect section, a PCA outputting section, and a PCA inputting section of the optical cross-connect device as shown in FIG. 22 when trouble occurs.

### BEST MODE FOR CARRYING OUT THE INVENTION

Below, embodiments of the present invention are explained with reference to the accompanying drawings.

In the embodiments of the present invention, an optical network is able to transmit two types of optical signals (priority signal and non-priority signal) having different transmission priority levels. Below, the non-priority signal is referred to as “PCA (Protected Channel Access) signal”.

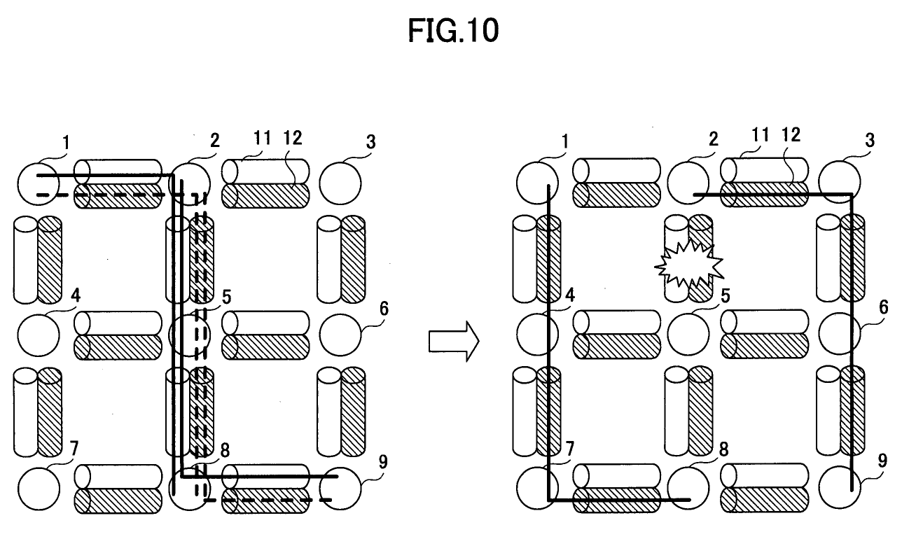

FIG. 10 is a diagram schematically illustrating an optical network according to a first embodiment, in which when a transmission path from a transmission node to a reception node is in trouble, the transmission path as a whole is switched, and only priority signals are transmitted through a new transmission path by using a preliminary optical fiber.

The optical network shown in FIG. 10 includes nine optical cross-connect devices (optical XC) 1 through 9, and optical fibers 11 being used presently and preliminary optical fibers 12, which connect the optical cross-connect devices 1 through 9.

Under normal conditions, consider that there is an optical signal transmission from a transmission node connected to the optical XC1 to a reception node connected to the optical XC8. In this case, the transmission path including the presently-used optical fibers 11 connecting the optical XC1, optical XC2, optical XC5, and optical XC8 is set as the transmission path of the priority signals. Similarly, the transmission path including the preliminary optical fibers 12 connecting the optical XC1, optical XC2, optical XC5, and optical XC8 is set as the transmission path of the PCA signals.

Next, consider that there is an optical signal transmission from a transmission node connected to the optical XC2 to a reception node connected to the optical XC9. In this case, a transmission path including the presently-used optical fibers 11 connecting the optical XC2, optical XC5, optical XC8, and the optical XC9 is set as the transmission path of the priority signals. Similarly, the transmission path including the preliminary optical fibers 12 connecting the optical XC2, optical XC5, optical XC8, and the optical XC9 is set as the transmission path of the PCA signals.

Under these conditions, suppose trouble occurs between the optical XC2 and the optical XC5. In this case, the priority signal transmission path including the presently-used optical fibers 11 connecting the optical XC2 and optical XC5 is switched, and after switching, the transmission path is constituted by the preliminary optical fibers 12.

Specifically, the priority signal transmission path constituted by the presently-used optical fibers 11 connecting the optical XC1, optical XC2, optical XC5, and optical XC8 is switched to a transmission path including the preliminary optical fibers 12 connecting the optical XC1, optical XC4, optical XC7, and the optical XC8. Further, the priority signal transmission path constituted by the presently-used optical fibers 11 connecting the optical XC2, optical XC5, optical XC8, and the optical XC9 is switched to a transmission path including the preliminary optical fibers 12 connecting the optical XC2, optical XC3, optical XC6, and the optical XC9.

Meanwhile, the PCA signal transmission path including the presently-used optical fibers 11 connecting the optical XC2 and optical XC5 is cancelled.

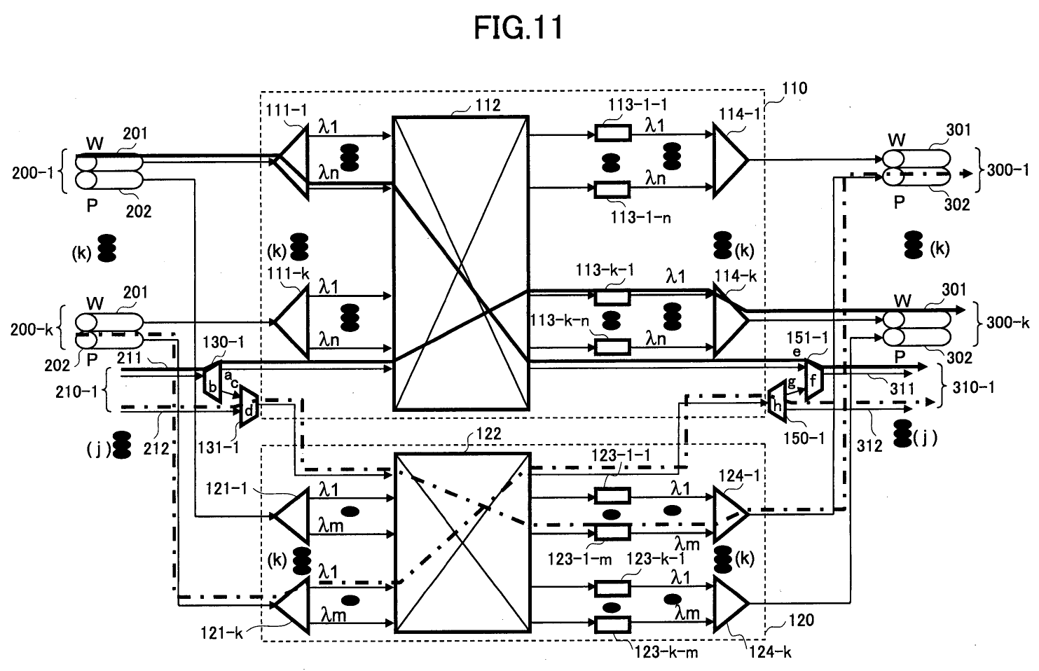

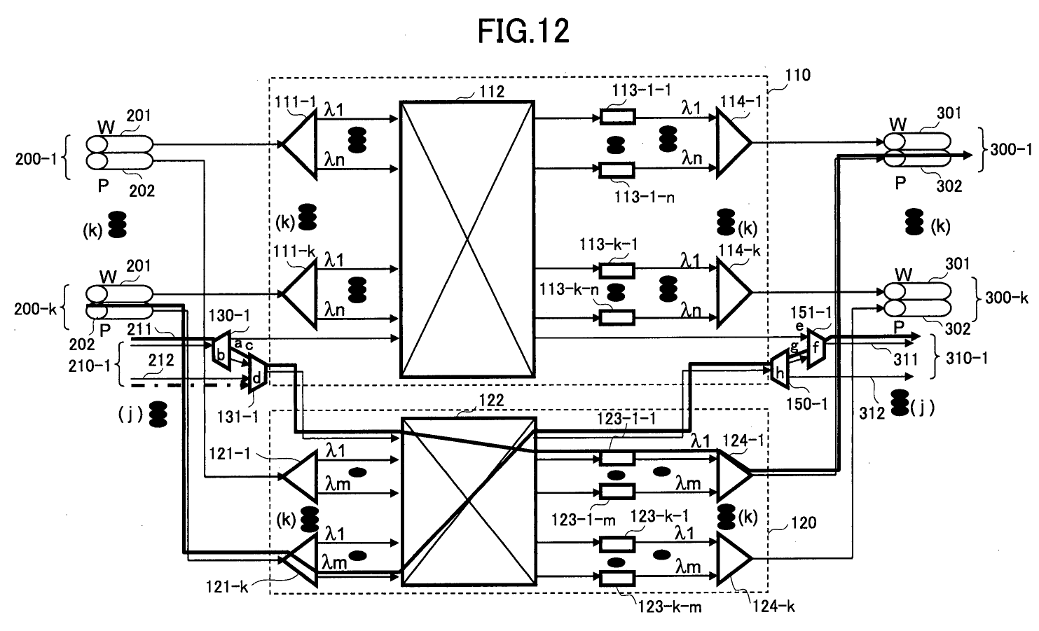

FIG. 11 and FIG. 12 are block diagrams illustrating configurations of an optical connect device used for switching the transmission path as shown in FIG. 10. In FIG. 11 and FIG. 12, thick solid lines indicate transmission paths of the priority signals, and thick dashed lines indicate transmission paths of the PCA signals.

The optical cross-connect device shown in FIG. 11 or FIG. 12 is connected to devices outside at the input side thereof through a number of k pairs of inter-station optical fibers 200-1 through 200-k, each pair of the optical fibers including a presently-used optical fiber (W) 201 and a preliminary optical fiber (P) 202, and is connected to devices inside through a number of j pairs of inner connection lines 210-1 through 210-j (collectively referred to as “inner connection lines 210” below where appropriate), each pair of the inner connection lines including a priority signal inner connection line 211 and a PCA signal inner connection line 212.

Similarly, the optical cross-connect device is connected to devices outside at the output side thereof through a number of k pairs of inter-station optical fibers 300-1 through 300-k, each pair of the optical fibers including a presently-used optical fiber (W) 301 and a preliminary optical fiber (P) 302, and is connected to devices inside through a number of j pairs of inner connection lines 310-1 through 310-j (collectively referred to as “inner connection lines 310” below where appropriate), each pair of the inner connection lines including a priority signal inner connection line 311 and a PCA signal inner connection line 312.

The optical cross-connect device includes a presently-used optical cross-connect section 110 connected with the presently-used optical fibers 201, 301, a preliminary optical cross-connect section 120 connected with the preliminary optical fibers 202, 302, optical branches (BRA) 130-1 through 130-j (collectively referred to as “optical branches 130” below where appropriate), optical selectors (SEL) 131-1 through 131-j (collectively referred to as “optical selectors 131” below where appropriate), optical branches (BRA) 150-1 through 150-j (collectively referred to as “optical branches 150” below where appropriate), and optical selectors (SEL) 151-1 through 151-j (collectively referred to as “optical selectors 151” below where appropriate).

In addition, the presently-used optical cross-connect section 110 includes optical de-multiplexers 111-1 through 111-k (collectively referred to as “optical de-multiplexers 111” below where appropriate), an optical switch 112, optical-electrical-optical (O/E/O) converters 113-1-1 through 113-k-n (collectively referred to as “O/E/O 113” below where appropriate), and optical multiplexers 114-1-1 through 114-k-n (collectively referred to as “optical multiplexers 114” below where appropriate).

Similarly, the preliminary optical cross-connect section 120 includes optical de-multiplexers 121-1 through 121-k (collectively referred to as “optical de-multiplexers 121” below where appropriate), an optical switch 122, optical-electrical-optical (O/E/O) converters 123-1-1 through 123-k-n (collectively referred to as “O/E/O 123” below where appropriate), and optical multiplexers 124-1-1 through 124-k-n (collectively referred to as “optical multiplexers 124” below where appropriate).

When the transmission path from a transmission node to a reception node is operating under normal conditions, as illustrated in FIG. 11, wavelength-multiplexed priority signals from devices outside are transmitted through the presently-used optical fiber 201, and are input to the presently-used optical cross-connect section 110.

An input end of each of the optical de-multiplexers 111-1 through 111-k in the presently-used optical cross-connect section 110 is connected to a corresponding presently-used optical fiber 201. Each of the optical de-multiplexers 111 de-multiplexes wavelength-multiplexed priority signals into signal components having specific wavelengths (here, denoted as λ1 to λn), and outputs these signal components to the optical switch 112.

Optical signals from devices inside are transmitted through the inner connection lines 211, and are input to the optical branches 130. The input terminal of each of the optical branches 130-1 through 130-j is connected to a corresponding inner connection line 211, an output terminal a of each of the optical branches 130-1 through 130-j is connected to the optical switch 112 in the presently-used optical cross-connect section 110, and an output terminal b of each of the optical branches 130-1 through 130-j is connected to a corresponding one of the optical selectors 131.

The optical branches 130 output the input priority signals to the optical switch 112 or the optical selectors 131. Here, the optical branches 130 output the priority signals from devices inside to the optical switch 112 in response to the fact that the priority signals from the devices outside are input to the optical switch 112 in the presently-used optical cross-connect section 110.

The optical switch 112, upon receiving the priority signals, switches the transmission path for the priority signals, and outputs the priority signals to the O/E/O 113 when it is necessary to further transmit the priority signals to outside, or to the optical selectors 151 when it is necessary to contain the priority signals inside.

The O/E/O 113 converts the input optical signals into electrical signals, shapes and amplifies the signals, converts the electrical signals into optical signals again, and outputs the signals into the optical multiplexers 114.

An output end of each of the optical multiplexers 114-1 through 114-k is connected to one of the presently-used optical fibers 301. These optical multiplexers 114 multiplex the input optical signals (priority signals) by wavelength multiplexing, and output the resulting signals into the presently-used optical fibers 301.

An input terminal e of each of the optical selectors 151-1 through 151-j is connected to the optical switch 112, and an input terminal f of each of the optical selectors 151-1 through 151-j is connected to a corresponding one of the optical branches 150. Meanwhile, the output terminal of each of the optical selectors 151-1 through 151-j is connected to a corresponding inner connection line 311.

One of the optical signals input to the two input terminals of each of the optical selectors 151 is output to the inner connection line 311. Here, the optical selectors 151 receive priority signals from the optical switch 112 only, and output the priority signals to the inner connection line 311 directly.

On the other hand, wavelength-multiplexed PCA signals from devices outside are transmitted through the preliminary optical fiber 202, and are input to the preliminary optical cross-connect section 120.

An input end of each of the optical de-multiplexers 121-1 through 121-k in the preliminary optical cross-connect section 120 is connected to a corresponding preliminary optical fiber 202. Each of the optical de-multiplexers 121 de-multiplexes wavelength-multiplexed PCA signals into signal components having specific wavelengths (here, denoted as λ1 to λm), and outputs these signal components to the optical switch 122.

Optical signals from devices inside are transmitted through the inner connection lines 212, and are input to the optical selectors 131. An input terminal c of each of the optical selectors 131-1 through 131-j is connected to a corresponding one of the optical branches 130-1 through 130-j, an input terminal d of each of the optical selectors 131-1 through 131-j is connected to a corresponding inner connection line 212, and an output terminal a of each of the optical selectors 131-1 through 131-j is connected to the optical switch 122 in the preliminary optical cross-connect section 120. The optical selectors 131 output one of the optical signals input to the two input ends thereof. Here, the optical selectors 131 receive the PCA signals from the inner connection line 211, and output the PCA signals to the optical switch 122 directly.

The optical switch 122, upon receiving the PCA signals, switches the transmission path for the PCA signals, and outputs the PCA signals to the O/E/O 123 when it is necessary to further transmit the PCA signals to outside, or to the optical branches 150 when it is necessary to transmit the PCA signals to inside.

The O/E/O 123 converts the input optical signals into electrical signals, shapes and amplifies the signals, converts the electrical signals into optical signals again, and outputs the signals into the optical multiplexers 124.

An output end of each of the optical multiplexers 124-1 through 124-k is connected to one of the presently-used optical fibers 301. These optical multiplexers 124 multiplex the input optical signals (PCA signals) by wavelength multiplexing, and output the resulting signals into the preliminary optical fibers 302.

The input terminal of each of the optical branches 150-1 through 150-j is connected to the optical switch 112, an output terminal g of each of the optical branches 150-1 through 150-j is connected to a corresponding one of the optical selectors 151-1 through 151-j, and an output terminal h of each of the optical branches 150-1 through 150-j is connected to a corresponding inner connection line 312.

The optical branches 150 output the input optical signals to the optical selectors 151 or the inner connection line 312. Here, the optical branches 150 receive the PCA signals from the optical switch 122 only, and output the PCA signals to the PCA signal inner connection line 312.

When a transmission path from a transmission node to a reception node is in trouble, as illustrated in FIG. 12, the wavelength-multiplexed priority signals from devices outside are transmitted through the preliminary optical fiber 202, and are input to the preliminary optical cross-connect section 120. Each of the optical de-multiplexers 121 in the preliminary optical cross-connect section 120 de-multiplexes wavelength-multiplexed priority signals into signal components having specific wavelengths (here, denoted as λ1 to λm), and outputs these signal components to the optical switch 122.

Optical signals from devices inside are transmitted through the inner connection lines 211, and are input to the optical branches 130. In response to the fact that trouble occurs and the priority signals from the devices outside are input to the optical switch 122 in the preliminary optical cross-connect section 120, the optical branches 130 output the optical signals from the devices inside to the optical selectors 131. The PCA signals from devices inside are transmitted through the inner connection lines 212, and are input to the optical selectors 131.

In response to the fact that trouble occurs and the priority signals from the devices outside are input to the optical switch 122, the optical selectors 131 select the priority signals out of the input priority signals and the PCA signals, and output the priority signals to the optical switch 122.

The optical switch 122, upon receiving the priority signals, switches the transmission path for the priority signals, and outputs the priority signals to the O/E/O 123 when it is necessary to further transmit the priority signals to outside, or to the optical branches 150 when it is necessary to contain the priority signals inside.

The O/E/O 123 converts the input optical signals into electrical signals, shapes and amplifies the signals, converts the electrical signals into optical signals again, and outputs the signals into the optical multiplexers 124.

An output end of each of the optical multiplexers 124-1 through 124-k is connected to one of the presently-used optical fibers 301. These optical multiplexers 124 multiplex the input optical signals (priority signals) by wavelength multiplexing, and output the resulting signals into the preliminary optical fibers 302.

The optical branches 150 output the input optical signals to the optical selectors 131 or the inner connection line 312. Here, in response to the fact that the input optical signals are the priority signals, the optical branches 150 output the priority signals to the optical selectors 151 so as to output the priority signals to the priority signals inner connection line 311. Here, the optical selectors 151 receive priority signals from the optical branches 150 only, and output the priority signals to the inner connection line 311 directly.

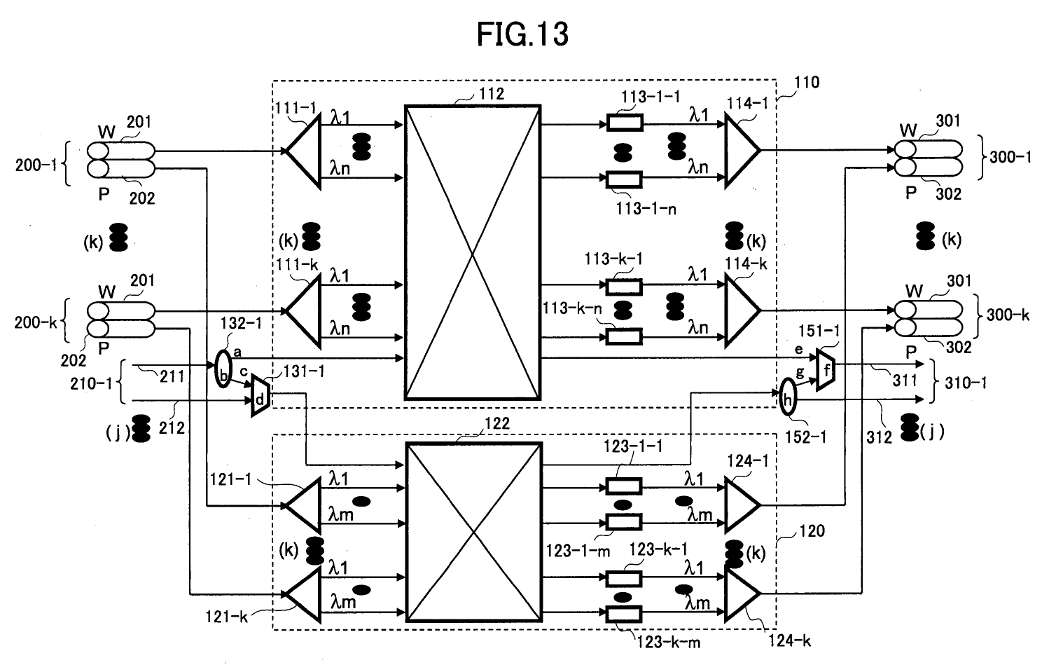

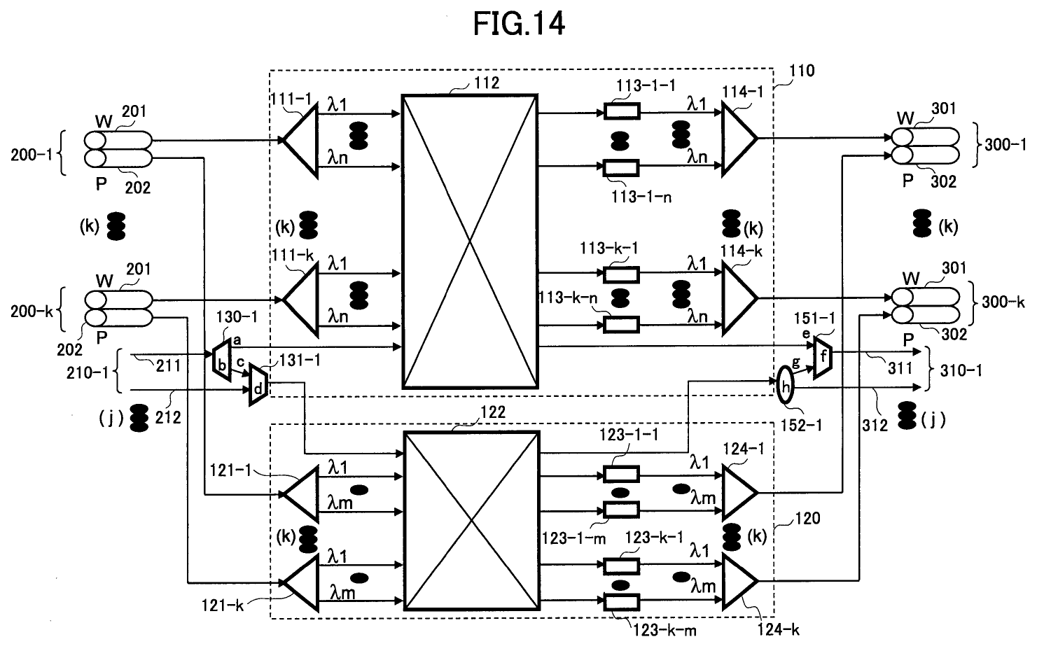

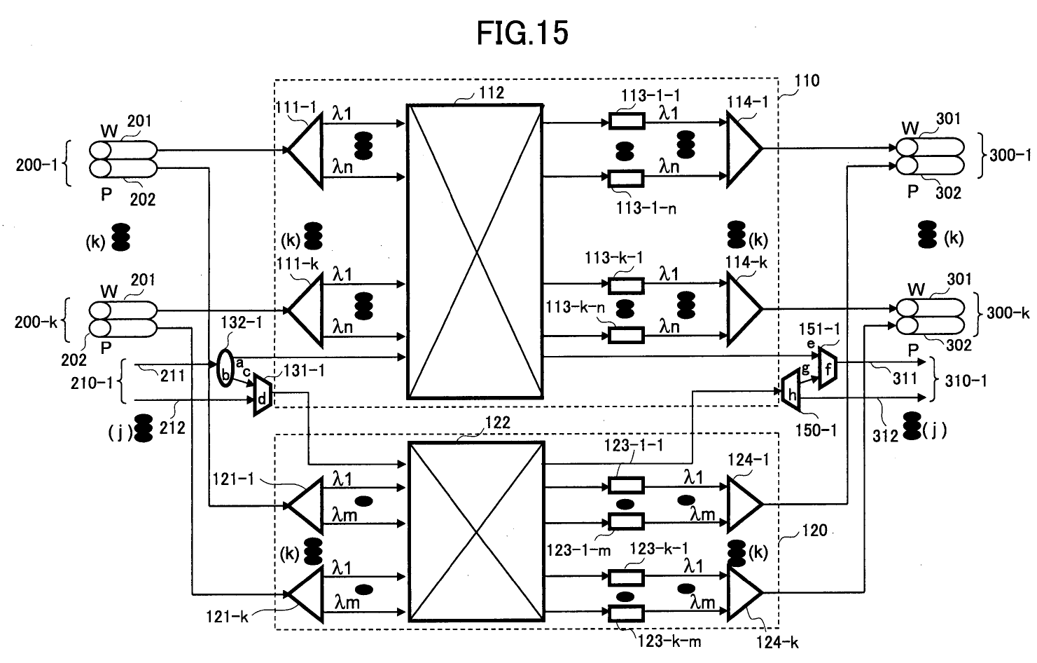

In FIG. 11 and FIG. 12, the optical branches 130 are provided to function as devices to determine the output destination of the priority signal from the inner connection line 211, and the optical branches 150 are provided to function as devices to determine the output destination of the PCA signal from the optical switch 122. However, as illustrated in FIG. 13, optical distributors 132 may be provided to replace the optical branches 130, and optical distributors 152 may be provided to replace the optical branches 150. Or, as illustrated in FIG. 14, only the optical branches 150 are replaced by the optical distributors 152, or as illustrated in FIG. 15, only the optical branches 130 are replaced by the optical distributors 132.

When the optical distributors 132 are provided to replace the optical branches 130, the optical distributors 132 output the priority signal from the inner connection line 211 to the optical switch 112 through the output terminal a, and to the optical selectors 131 through the output terminal b. At this moment, the optical switch 112 switches the transmission path only when the transmission path is operating under the normal conditions, but does not do that when trouble occurs. The optical selectors 131 output the PCA signals from the inner connection lines 312 to the optical switch 122 when the transmission path is operating under the normal conditions, and output the priority signals from the optical distributors 132 to the optical switch 112 when trouble occurs.

When the optical distributors 152 are provided to replace the optical branches 150, the optical distributors 152 output the PCA signal from the optical switch 122 to the optical selectors 151 through the output terminal g, and to the inner connection line 312 through the output terminal h. At this moment, the optical selectors 151 output the priority signals from the optical switch 112 to the inner connection lines 311. Meanwhile, when trouble occurs, the optical distributors 152 output the priority signals from the optical switch 122 to the optical selectors 151 through the output terminal g, and to the inner connection lines 312 through the output terminal h. At this moment, the optical selectors 151 output the priority signals from the optical switch 112 to the inner connection lines 311.

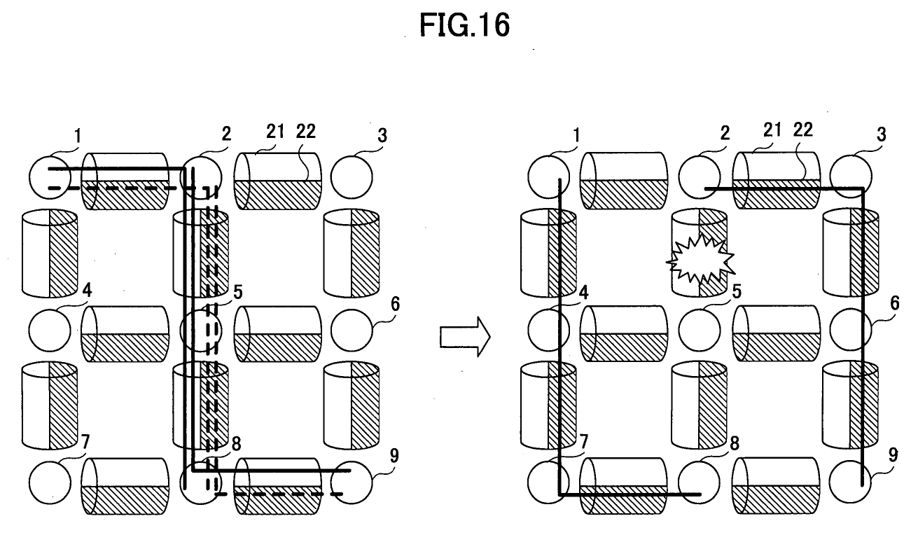

FIG. 16 is a diagram schematically illustrating an optical network according to a second embodiment, in which when a transmission path from a transmission node to a reception node is in trouble, the transmission path as a whole is switched, and only priority signals are transmitted through a new transmission path in a preliminary wavelength band of an optical fiber.

The optical network shown in FIG. 16 includes nine optical cross-connect devices (optical XC) 1 through 9, and a wavelength band 21 being used presently and a preliminary wavelength band 22, which connect the optical cross-connect devices 1 through 9.

Under normal conditions, consider that there is an optical signal transmission from a transmission node connected to the optical XC1 to a reception node connected to the optical XC8. In this case, the transmission path including the presently-used wavelength band 21 connecting the optical XC1, the optical XC2, the optical XC5, and the optical XC8, is set as the transmission path of the priority signals. Similarly, the transmission path including the preliminary wavelength band 22 connecting the optical XC1, the optical XC2, the optical XC5, and the optical XC8 is set as the transmission path of the PCA signals.

Next, consider that there is an optical signal transmission from a transmission node connected to the optical XC2 to a reception node connected to the optical XC9. In this case, a transmission path including the presently-used wavelength band 21 connecting the optical XC2, the optical XC5, the optical XC8, and the optical XC9, is set as the transmission path of the priority signals. Similarly, the transmission path including the preliminary wavelength band 22 connecting the optical XC2, the optical XC5, the optical XC8, and the optical XC9 is set as the transmission path of the PCA signals.

Under these conditions, suppose trouble occurs between the optical XC2 and the optical XC5. In this case, the whole priority signal transmission path including the presently-used wavelength band 21 connecting the optical XC2 and optical XC5 is switched, and after switching, the transmission path is constituted by the preliminary wavelength band 22. Specifically, the priority signal transmission path constituted by the presently-used wavelength band 21 connecting the optical XC1, optical XC2, optical XC5, and optical XC8, is switched to a transmission path including the preliminary wavelength band 22 connecting the optical XC1, optical XC4, optical XC7, and the optical XC8. Further, the priority signal transmission path constituted by the presently-used wavelength band 21 connecting the optical XC2, optical XC5, optical XC8, and the optical XC9 is switched to a transmission path including the preliminary wavelength band 22 connecting the optical XC2, optical XC3, optical XC6, and the optical XC9.

Meanwhile, the PCA signal transmission path including the preliminary wavelength band 22 connecting the optical XC2 and optical XC5 is cancelled.

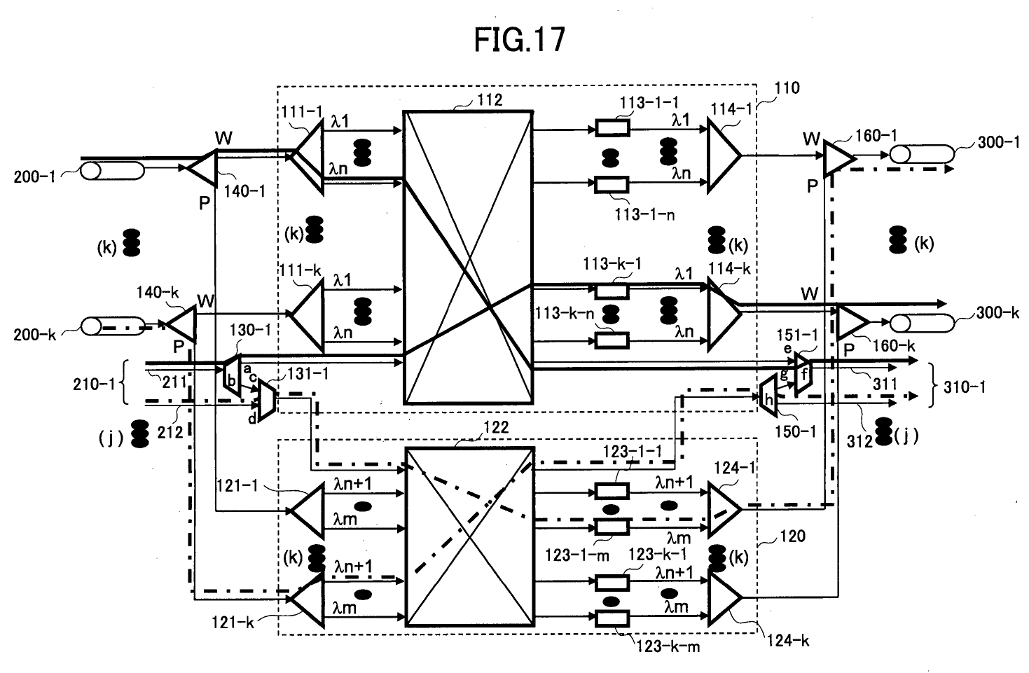

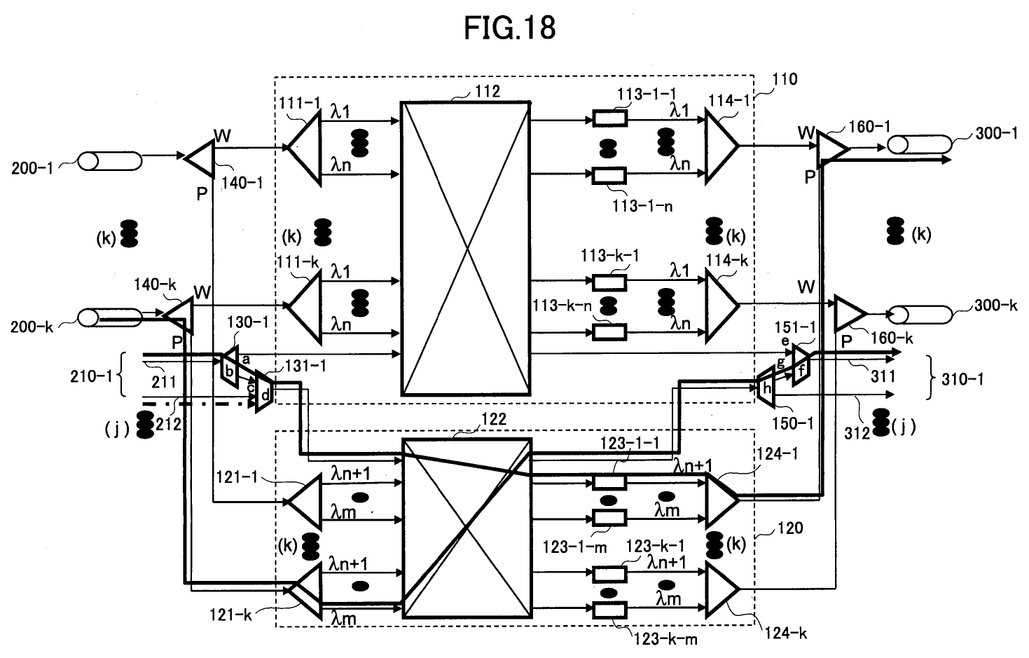

FIG. 17 and FIG. 18 are block diagrams illustrating configurations of an optical connect device used for switching the transmission path as shown in FIG. 16. In FIG. 17 and FIG. 18, thick solid lines indicate transmission paths of the priority signals, and thick dashed lines indicate transmission paths of the PCA signals.

Compared to FIG. 11 and FIG. 12, the optical cross-connect device in FIG. 17 and FIG. 18 further includes wavelength separators 140-1 to 140-k (collectively referred to as “wavelength separators 140” below where appropriate), and optical synthesizers 160-1 to 160-k (collectively referred to as “optical synthesizers 160” below where appropriate).

The optical cross-connect device is connected to devices outside at the input side thereof through inter-station optical fibers 200-1 through 200-k, each of the optical fibers including a presently-used wavelength band (W) and a preliminary wavelength band (P), and is connected to devices inside through a number of j pairs of inner connection lines 210-1 through 210-j (collectively referred to as “inner connection lines 210” below where appropriate), each pair of the inner connection lines including a priority signal inner connection line 211 and a PCA signal inner connection line 212.

Similarly, the optical cross-connect device is connected to devices outside at the output side thereof through inter-station optical fibers 300-1 through 300-k, each of the optical fibers including a presently-used wavelength band (W) 301 and a preliminary wavelength band (P) 302, and is connected to devices inside through a number of j pairs of inner connection lines 310-1 through 310-j (collectively referred to as “inner connection lines 310” below where appropriate), each pair of the inner connection lines including a priority signal inner connection line 311 and a PCA signal inner connection line 312.

When the transmission path from a transmission node to a reception node is operating under normal conditions, as illustrated in FIG. 17, wavelength-multiplexed optical signals from devices outside are transmitted through the presently-used wavelength band (W) of the inter-station optical fibers 200, and are respectively input to the wavelength separators 140.

An input terminal of each of the wavelength separators 140-1 to 140-k is connected to a corresponding inter-station optical fiber 200, and two output terminals of each of the wavelength separators 140-1 to 140-k are connected to the presently-used optical cross-connect section 110 and the preliminary optical cross-connect section 120. The wavelength separators 140 separate the priority signals transmitted through the presently-used wavelength band of the inter-station optical fibers 200 and the PCA signals transmitted through the preliminary wavelength band of the inter-station optical fibers 200, and output the priority signals to the presently-used optical cross-connect section 110 and the PCA signals to the preliminary optical cross-connect section 120.

An input end of each of the optical de-multiplexers 111-1 through 111-k in the presently-used optical cross-connect section 110 is connected to one corresponding wavelength separator 140. Each of the optical de-multiplexers 111 de-multiplexes wavelength-multiplexed priority signals into signal components having specific wavelengths (here, denoted as λ1 to λn), and outputs these signal components to the optical switch 112.

Optical signals from devices inside are transmitted through the inner connection lines 211, and are input to the optical branches 130. The optical branches 130 output the input priority signals to the optical switch 112 or the optical selectors 131.

Here, in response to the fact that the priority signals from the devices outside are input to the optical switch 112 in the presently-used optical cross-connect section 110, the optical branches 130 output the priority signals from the devices inside to the optical switch 112.

The optical switch 112, upon receiving the priority signals, switches the transmission path for the priority signals, and outputs the priority signals to the O/E/O 113 when it is necessary to further transmit the priority signals to outside, or to the optical selectors 151 when it is necessary to contain the priority signals inside.

The O/E/O 113 converts the input optical signals into electrical signals, shapes and amplifies the signals, converts the electrical signals into optical signals again, and outputs the signals into the optical multiplexers 114.

An output end of each of the optical multiplexers 114-1 through 114-k is connected to one of the presently-used optical fibers 301. These optical multiplexers 114 multiplex the input optical signals (priority signals) by wavelength multiplexing, and output the resulting signals into the optical synthesizers 160.

One of two input terminals of each of the optical selectors 151 is connected to one corresponding inner connection line 311. Here, the optical selectors 151 receive priority signals from the optical switch 112 only, and output the priority signals to the inner connection line 311 directly.

An input end of each of the optical de-multiplexers 121-1 through 121-k in the preliminary optical cross-connect section 120 is connected to a corresponding wavelength separator 140. Each of the optical de-multiplexers 121 de-multiplexes wavelength-multiplexed PCA signals into signal components having specific wavelengths (here, denoted as λ1 to λm), and outputs these signal components to the optical switch 122.

On the other hand, PCA signals from devices inside are transmitted through the inner connection lines 212, and are input to the optical selectors 131. The optical selectors 131 output one of the optical signals input to the two input ends thereof. Here, the optical selectors 131 receive the PCA signals from the inner connection line 212, and output the PCA signals to the optical switch 122 directly.

The optical switch 122, upon receiving the PCA signals, switches the transmission path for the PCA signals, and outputs the PCA signals to the O/E/O 123 when it is necessary to further transmit the PCA signals to outside, or to the optical branches 150 when it is necessary to transmit the PCA signals to inside.

The O/E/O 123 converts the input optical signals into electrical signals, shapes and amplifies the signals, converts the electrical signals into optical signals again, and outputs the signals into the optical multiplexers 124. The optical multiplexers 124 multiplex the input optical signals (PCA signals) by wavelength multiplexing, and output the resulting signals into the optical synthesizers 160.

The optical branches 150 output the input optical signals to the optical selectors 151 or the inner connection line 312. Here, the optical branches 150 receive the PCA signals from the optical switch 122 only, and output the PCA signals to the PCA signal inner connection line 312.

Two input terminals of each of the optical synthesizers 160-1 to 160-k are connected to the optical multiplexers 114 in the presently-used optical cross-connect section 110 and the optical multiplexers 124 in the preliminary optical cross-connect section 120, and an output terminal of each of the optical synthesizers 160-1 to 160-k is connected to a corresponding inter-station optical fibers 300. The optical synthesizers 160 output the priority signals from the optical multiplexers 114 in the presently-used optical cross-connect section 110 to the presently-used wavelength band of the inter-station optical fiber 300, and output the PCA signals from the optical multiplexers 124 in the preliminary optical cross-connect section 120 to the preliminary wavelength band of the inter-station optical fiber 300.

When a transmission path from a transmission node to a reception node is in trouble, as illustrated in FIG. 18, the wavelength-multiplexed priority signals from devices outside are transmitted through the preliminary wavelength band of the inter-station optical fiber 200, and are input to the wavelength separators 140. The wavelength separators 140 output the priority signals transmitted through the preliminary wavelength band of the inter-station optical fiber 200 to the preliminary optical cross-connect section 120.

Optical signals from devices inside are transmitted through the inner connection lines 211, and are input to the optical branches 130. In response to the fact that trouble occurs and the priority signals from the devices outside are input to the optical switch 122 in the preliminary optical cross-connect section 120, the optical branches 130 output the optical signals from the devices inside to the optical selectors 131. The PCA signals from devices inside are transmitted through the inner connection lines 212, and are input to the optical selectors 131.

In response to the fact that trouble occurs and the priority signals from the devices outside are input to the optical switch 122, the optical selectors 131 select the priority signals out of the input priority signals and the PCA signals, and output the priority signals to the optical switch 122.

The optical switch 122, upon receiving the priority signals, switches the transmission path for the priority signals, and outputs the priority signals to the O/E/O 123 when it is necessary to further transmit the priority signals to outside, or to the optical branches 150 when it is necessary to contain the priority signals inside.

The O/E/O 123 converts the input optical signals into electrical signals, shapes and amplifies the signals, converts the electrical signals into optical signals again, and outputs the signals into the optical multiplexers 124.

The optical multiplexers 124 multiplex the input optical signals (priority signals) by wavelength multiplexing, and output the resulting signals into the optical synthesizers 160.

The optical synthesizers 160 output the priority signals from the optical multiplexers 124 in the presently-used optical cross-connect section 120 to the preliminary wavelength band of the inter-station optical fiber 300.

In response to the fact that the input optical signals are the priority signals, the optical branches 150 output the priority signals to the optical selectors 151 so as to output the priority signals to the priority signals inner connection line 311. The optical selectors 151 receive priority signals from the optical branches 150 only, and output the priority signals to the inner connection line 311 directly.

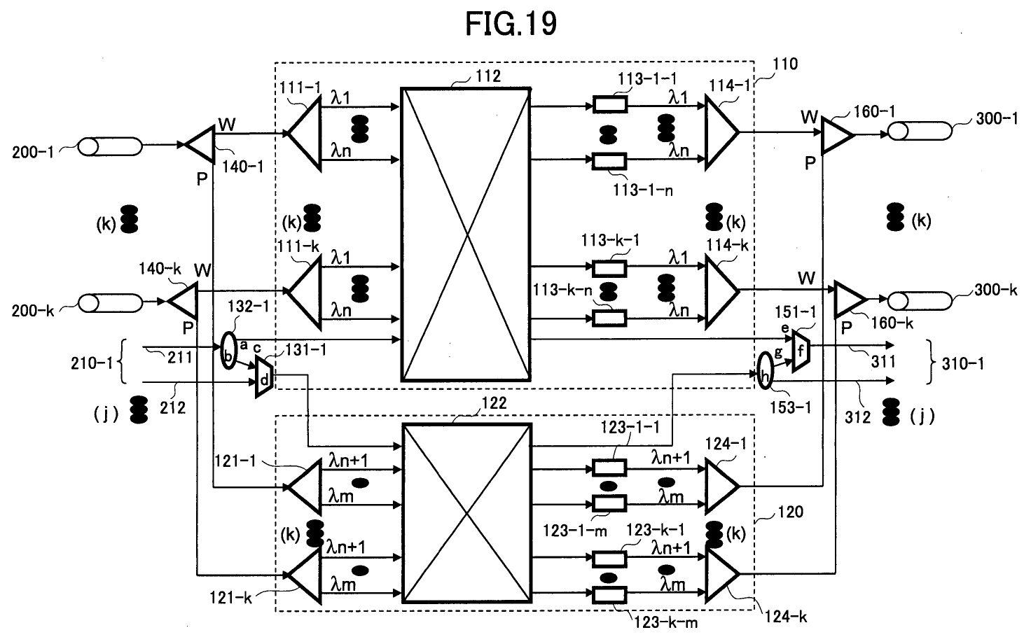

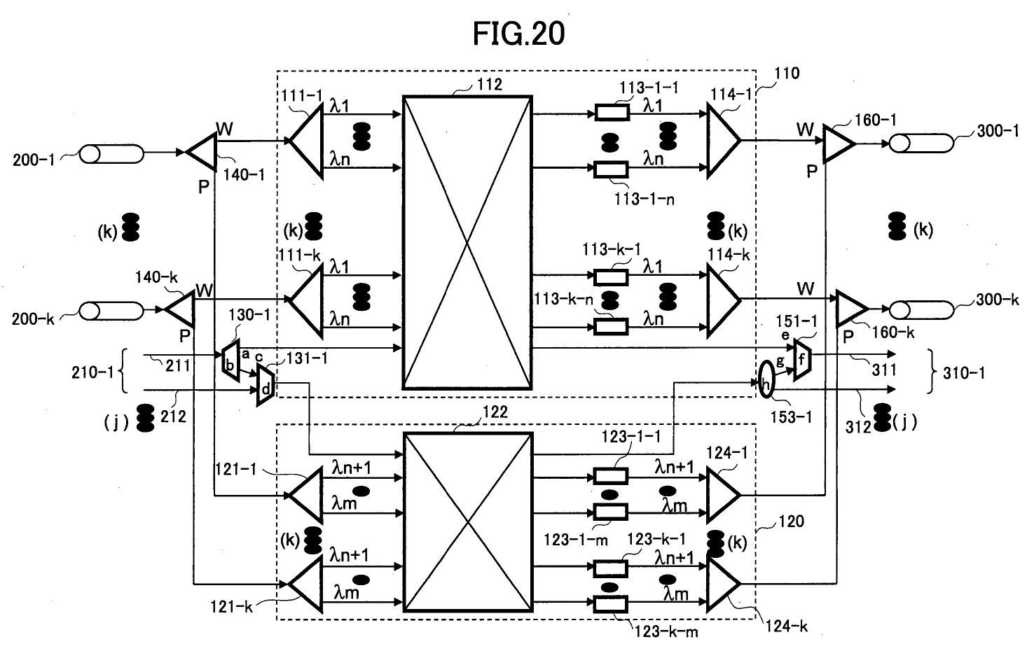

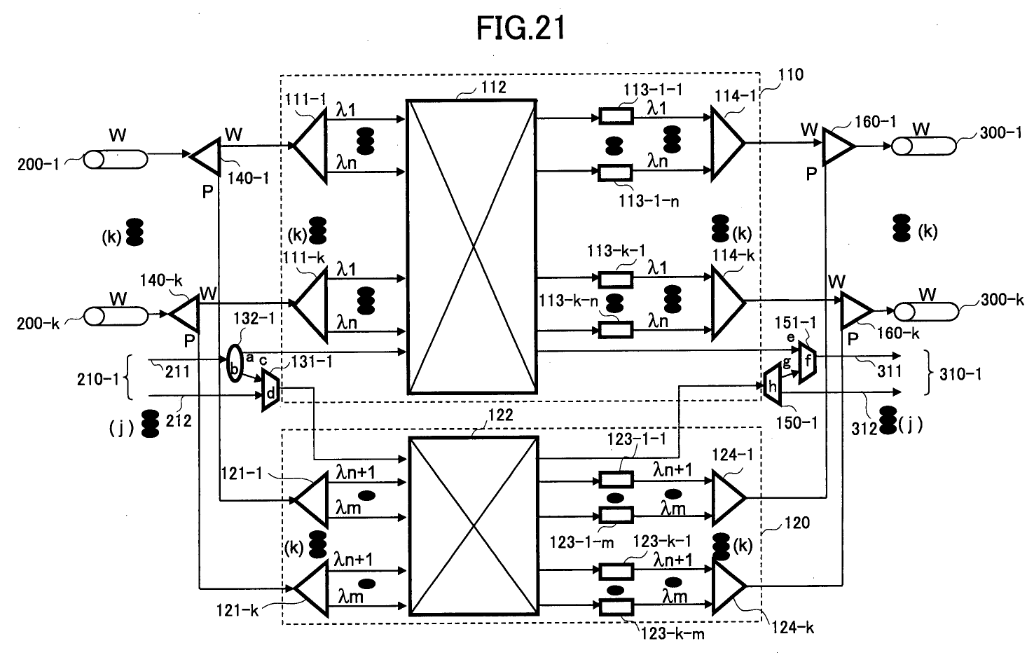

In FIG. 17 and FIG. 18, the optical branches 130 are provided to function as devices to determine the output destination of the priority signal from the inner connection line 211, and the optical branches 150 are provided to function as devices to determine the output destination of the PCA signal from the optical switch 122. However, as illustrated in FIG. 19, optical distributors 132 may be provided to replace the optical branches 130, and optical distributors 153 may be provided to replace the optical branches 150. Or, as illustrated in FIG. 20, only the optical branches 150 are replaced by the optical distributors 153, or as illustrated in FIG. 21, only the optical branches 130 are replaced by the optical distributors 132.

When the optical distributors 132 are provided to replace the optical branches 130, the optical distributors 132 output the priority signal from the inner connection line 311 to the optical switch 112 through the output terminal a, and to the optical selectors 131 through the output terminal b. At this moment, the optical switch 112 switches the transmission path only when the transmission path is under normal conditions, but does not do that when trouble occurs. The optical selectors 131 output the PCA signals from the inner connection lines 312 to the optical switch 122 when the transmission path is under normal conditions, and output the priority signals from the optical distributors 132 to the optical switch 122 when trouble occurs.

When the optical distributors 153 are provided to replace the optical branches 150, the optical distributors 153 output the PCA signal from the optical switch 122 to the optical selectors 151 through the output terminal g, and to the inner connection line 312 through the output terminal h. At this moment, the optical selectors 151 output the priority signals from the optical switch 112 to the inner connection lines 311. Meanwhile, when trouble occurs, the optical distributors 153 output the priority signals from the optical switch 122 to the optical selectors 151 through the output terminal g, and to the inner connection lines 312 through the output terminal h. At this moment, the optical selectors 151 output the priority signals from the optical switch 112 to the inner connection lines 311.

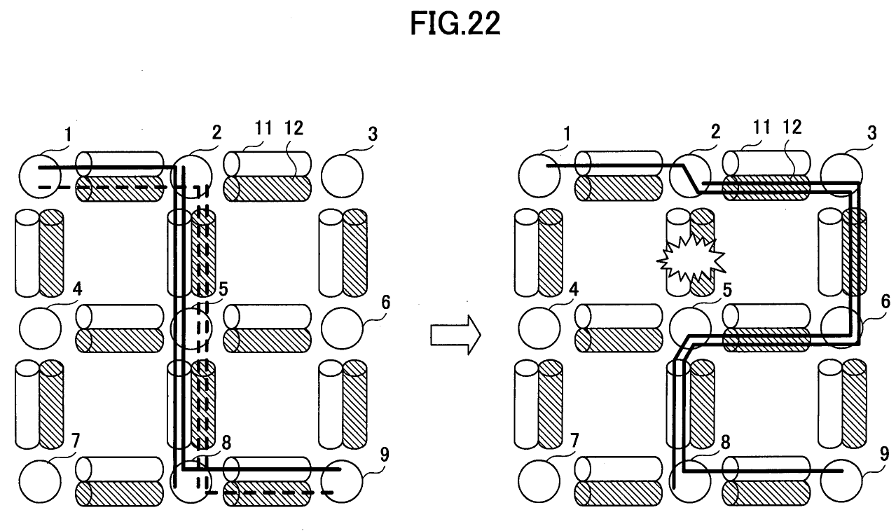

FIG. 22 is a diagram schematically illustrating an optical network according to a third embodiment, in which when a transmission path from a transmission node to a reception node is in trouble, only a section of the transmission path including the trouble spot is switched to an alternate path, and optical signals are transmitted through a preliminary fiber in the alternate path.

The optical network shown in FIG. 22 includes nine optical cross-connect devices (optical XC) 1 through 9, and optical fibers 11 being used presently and preliminary optical fibers 12, which connect the optical cross-connect devices 1 through 9.

Under normal conditions, consider that there is an optical signal transmission from a transmission node connected to the optical XC1 to a reception node connected to the optical XC8. In this case, the transmission path including the presently-used optical fibers 11 connecting the optical XC1, optical XC2, optical XC5, and optical XC8 is set as the transmission path of the priority signals. Similarly, the transmission path including the preliminary optical fibers 12 connecting the optical XC1, optical XC2, optical XC5, and optical XC8 is set as the transmission path of the PCA signals.

Next, consider that there is an optical signal transmission from a transmission node connected to the optical XC2 to a reception node connected to the optical XC9. In this case, a transmission path including the presently-used optical fibers 11 connecting the optical XC2, optical XC5, optical XC8, and the optical XC9 is set as the transmission path of the priority signals. Similarly, the transmission path including the preliminary optical fibers 12 connecting the optical XC2, optical XC5, optical XC8, and the optical XC9 is set as the transmission path of the PCA signals.

Under these conditions, suppose trouble occurs between the optical XC2 and the optical XC5. In this case, the priority signal transmission path including the presently-used optical fibers 11 connecting the optical XC2 and optical XC5 is switched to the alternate path, and the alternate path is constituted by the preliminary optical fibers 12.

Specifically, in the priority signal transmission path constituted by the presently-used optical fibers 11 connecting the optical XC1, optical XC2, optical XC5, and optical XC8, a section from the optical XC2 to the optical XC5 including the trouble spot is switched to the alternate path including the preliminary optical fibers 12 connecting the optical XC2, optical XC3, optical XC6, and the optical XC5. Further, in the priority signal transmission path constituted by the presently-used optical fibers 11 connecting the optical XC2, optical XC5, optical XC8, and the optical XC9, the section from the optical XC2 to the optical XC5 including the trouble spot is switched to the alternate path including the preliminary optical fibers 12 connecting the optical XC2, optical XC3, optical XC6, and the optical XC5.

Meanwhile, the PCA signal transmission path including the preliminary optical fibers 12 connecting the optical XC2 and optical XC5 is cancelled.

Below, an explanation is made of optical connect devices (the optical XC3 and XC6 in FIG. 22) provided in the alternate path.

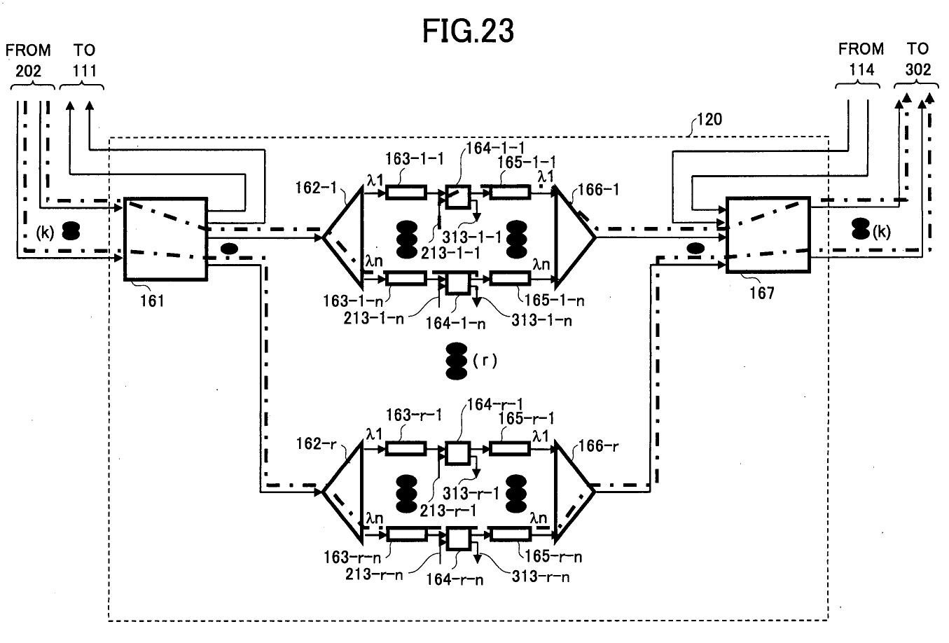

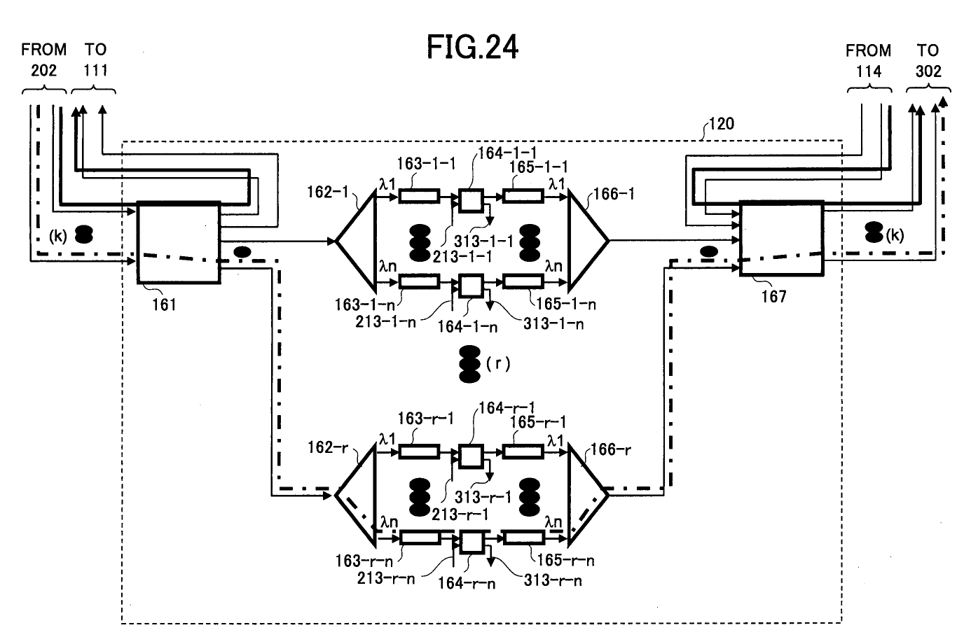

FIG. 23 and FIG. 24 are block diagrams illustrating examples of configurations of a preliminary optical cross-connect section of an optical connect device used for switching the transmission path as shown in FIG. 22. In FIG. 23 and FIG. 24, thick solid lines indicate transmission paths of the priority signals, and thick dashed lines indicate transmission paths of the PCA signals. In addition, except for the preliminary optical cross-connect section, the configuration of the optical connect device is the same as those in FIG. 11 and FIG. 12.

The preliminary optical cross-connect section 120 in FIG. 23 and FIG. 24 is connected to devices outside at the input side thereof through a number of k preliminary optical fibers (P) 202, and is connected to devices outside at the output side thereof through a number of k preliminary optical fibers (P) 302.

The preliminary optical cross-connect section 120 includes optical switch 161, optical de-multiplexers 162-1 through 162-r (collectively referred to as “optical multiplexers 162” below where appropriate), optical-electrical-optical (O/E/O) converters 163-1-1 through 163-r-m (collectively referred to as “O/E/O 163” below where appropriate), optical switches 164-1-1 through 164-r-m (collectively referred to as optical switches 164 below where appropriate), optical-electrical-optical (O/E/O) converters 165-1-1 through 165-r-m (collectively referred to as “O/E/O 165” below where appropriate), optical multiplexers 166-1-1 through 166-r-m (collectively referred to as “optical multiplexers 166” below where appropriate), and optical switch 167.

When the transmission path from a transmission node to a reception node is operating under normal conditions, as illustrated in FIG. 23, wavelength-multiplexed non-priority signals from devices outside are transmitted through the preliminary optical fiber 202, and are input to the optical switch 161.

The optical switch 161, upon receiving the optical signals, switches the transmission path for the optical signals, and outputs the optical signals to the optical de-multiplexers 111 (not-illustrated) in the presently-used optical cross-connect section or to the optical de-multiplexers 162. Here, the optical switch 161 receives the non-priority signals only, and for this purpose, the optical switch 161 outputs the non-priority signals to the optical de-multiplexers 162.

Each of the optical de-multiplexers 162 de-multiplexes wavelength-multiplexed non-priority signals into signal components having specific wavelengths (here, denoted as λ1 to λn), and outputs these signal components to the O/E/O 163.

The O/E/O 163 converts the input optical signals into electrical signals, shapes and amplifies the signals, converts the electrical signals into optical signals again, and outputs the signals to the optical switches 164.

An input end of each of the optical switches 164-1-1 through 164-r-n is connected to one of the corresponding O/E/O 163 and the corresponding non-priority signal inner connection line 213; an output end of each of the optical switches 164-1-1 through 164-r-n is connected to the corresponding O/E/O 165 and the corresponding non-priority signal inner connection line 313.

Upon receiving the non-priority signals from the O/E/O 163 and the corresponding non-priority signal inner connection line 213, the optical switch 164 switches the transmission path in response to the non-priority signal inner connection line, and outputs the non-priority signals to the O/E/O 165 when it is necessary to further transmit the non-priority signals to outside, or to the non-priority signal inner connection line 313 when it is necessary to contain the non-priority signals inside.

The O/E/O 165 converts the input optical signals into electrical signals, shapes and amplifies the signals, converts the electrical signals into optical signals again, and outputs the signals into the optical multiplexers 166.

The optical multiplexers 164 multiplex the input optical signals (non-priority signals) by wavelength multiplexing, and output the resulting signals into the optical switch 167.

Upon receiving the non-priority signals, the optical switch 167 switches the transmission paths, and outputs the non-priority signals to the preliminary optical fibers (P) 302.

When a transmission path from a transmission node to a reception node is in trouble, as illustrated in FIG. 24, the priority signals from the devices outside, which are transmitted through the preliminary optical fiber 202, are input to the optical switch 161.

The optical switch 161, upon receiving the priority signals, switches the transmission path for the priority signals. Here, the priority signals are input. For this purpose, the optical switch 161 outputs the priority signals to the optical de-multiplexers 111 (not-illustrated) in the presently-used optical cross-connect section. Upon receiving the priority signals, the presently-used optical cross-connect section operates following the procedure as described in FIG. 12 to switch the transmission path.

When the optical cross-connect device is provided in the alternate path for the priority signals, the optical multiplexers 114 in the presently-used optical cross-connect section output the input priority signals to the optical switch 167 in the preliminary optical cross-connect section 120.

The optical switch 167, upon receiving the priority signals, switches the transmission path for the priority signals, and outputs the priority signals to the preliminary optical fibers 302.

The non-priority signals through a transmission path not including the trouble spot, the same as in FIG. 23, are input to the preliminary optical cross-connect section 120. Then, the non-priority signals are input to the optical switches 167 via the optical switch 161, the optical de-multiplexers 162, the O/E/O 163, the optical switches 164, the O/E/O 165, and the optical multiplexers 166.

Upon receiving the priority signals, the optical switch 167 outputs the input optical signals to the preliminary optical fibers 302 when the preliminary optical fibers 302, serving as the output destination, are not the alternate paths of the priority signals.

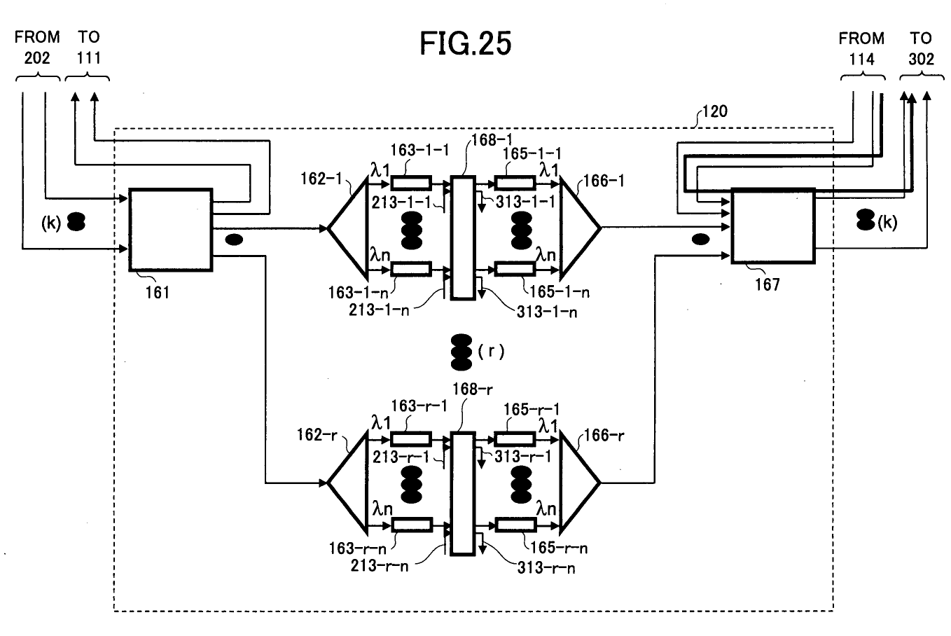

In FIG. 23 and FIG. 24, the optical switch 164 is provided to correspond to one O/E/O 163, one inner connection line 213, one O/E/O 165, and one inner connection line 313. However, as illustrated in FIG. 25, an optical switch 168 may be provided to correspond to one optical de-multiplexer 162 and one optical multiplexer 166, receives the non-priority signals from plural O/E/Os 163 and plural inner connection lines 213, and outputs the non-priority signals from plural O/E/Os 165 and plural inner connection lines 313.

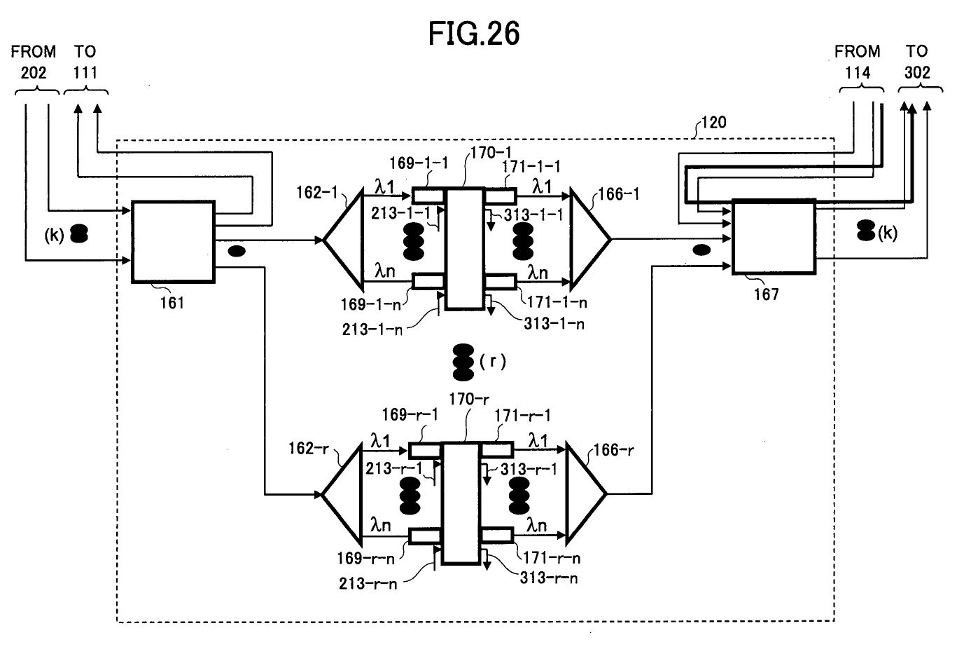

In addition, as illustrated in FIG. 26, corresponding to one optical de-multiplexer 162 and one optical multiplexer 165, there may be provided an electrical switch 170 for switching electrical signals, plural optical-electrical (O/E) converters 169 for receiving the optical signals de-multiplexed by the optical de-multiplexer 162, converting the signals into electrical signals, and outputting the signals to the electrical switch 170, and plural electrical-optical (E/O) converters 171 for receiving the electrical signals from the electrical switch 170, converting the signals into optical signals, and outputting the signals to the optical multiplexer 166.

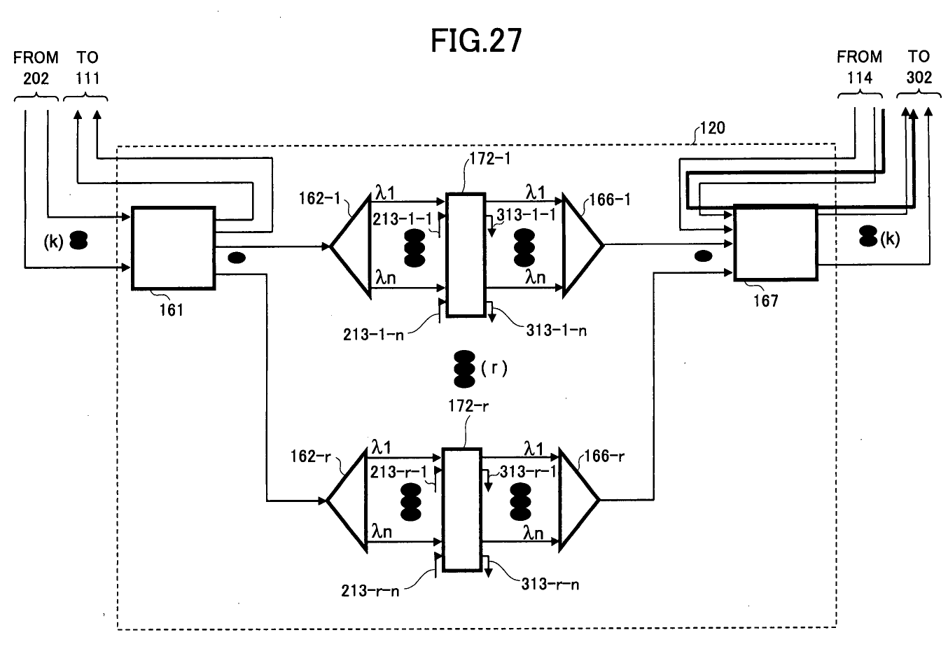

Further, as illustrated in FIG. 27, an electrical switch 172 including O/E and E/O may be provided to replace the optical-electrical converters 169, the electrical switch 170, and the electrical-optical (E/O) converters 171 shown in FIG. 26.

In addition, the structure for outputting the non-priority signals to the inside and the structure for inputting the non-priority signals from the inside may be arranged outside the preliminary optical cross-connect section 120.

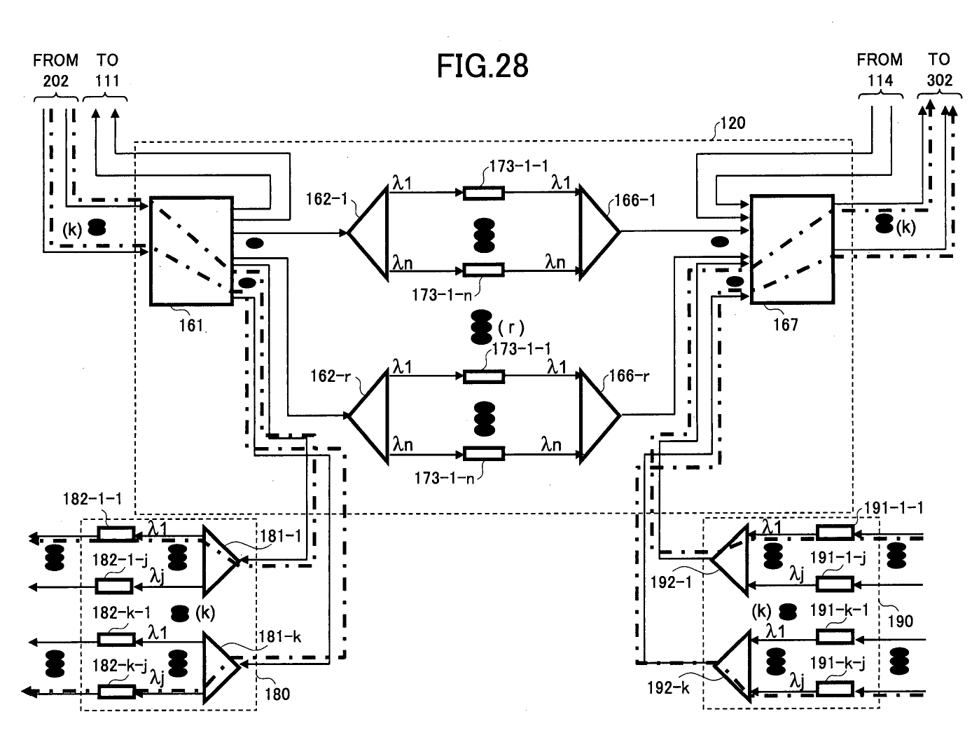

FIG. 28 is a block diagram illustrating another example of a configuration of a preliminary optical cross-connect section, a PCA outputting section, and a PCA inputting section of an optical cross-connect device used for switching the transmission path as shown in FIG. 22. In FIG. 28, thick solid lines indicate transmission paths of the priority signals, and thick dashed lines indicate transmission paths of the PCA signals. In addition, except for the preliminary optical cross-connect section, the configuration of the optical connect device is the same as those in FIG. 11 and FIG. 12.

Compared to FIG. 23 and FIG. 24, the preliminary optical cross-connect section 120 in FIG. 28 includes O/E/O 173 instead of the O/E/O 163, the optical switches 164, and the O/E/O 165. In addition, the output terminals of the optical switch 161 are connected to a PCA outputting section 180, and the optical switch 161 outputs the non-priority signals contained in the preliminary optical cross-connect section 120 to the inside. The input terminals of the optical switch 167 are connected to a PCA inputting section 190 so that the optical switch 167 allocates the non-priority signals from the inside to the preliminary optical cross-connect section 120.

When the non-priority signals from the outside to the inside are input to the preliminary optical cross-connect section 120 via the preliminary optical fibers 202, upon receiving the non-priority signals from the preliminary optical fibers 202, the optical switch 161 outputs the non-priority signals to the PCA outputting section 180 if it is necessary to allocate the non-priority signals to the inside.

The PCA outputting section 180 includes optical de-multiplexers 181-1 through 181-k (collectively referred to as “optical de-multiplexers 181” below where appropriate) having the same number as the preliminary optical fibers 202, and optical-electrical-optical (O/E/O) converters 182-1-1 through 182-k-n (collectively referred to as “O/E/O 182” below where appropriate).

The optical de-multiplexers 181 de-multiplex the wavelength-multiplexed optical signals into signal components having specific wavelengths (here, denoted as λ1 to λn), and outputs these signal components to the O/E/O 182.

The O/E/O 182 converts the input optical signals into electrical signals, shapes and amplifies the signals, converts the electrical signals into optical signals again, and outputs the signals to the inside.

The non-priority signals from the inside to the outside are input to the PCA inputting section 190. The PCA inputting section 190 includes optical-electrical-optical (O/E/O) converters 191-1-1 through 191-k-n (collectively referred to as “O/E/O 191” below where appropriate), and optical multiplexers 192-1 through 192-k (collectively referred to as “optical multiplexers 192” below where appropriate) having the same number as the preliminary optical fibers 302.

The O/E/O 191 converts the input optical signals (non-priority signals) from the inside into electrical signals, shapes and amplifies the signals, converts the electrical signals into optical signals again, and outputs the signals to the optical multiplexers 192. The optical multiplexers 192 multiplex the input optical signals (non-priority signals) by wavelength multiplexing, and output the resulting signals to the optical switch 167.

The optical switch 167, upon receiving the non-priority signals from the PCA inputting section 190, outputs the non-priority signals to the preliminary optical fibers 302 if it is necessary to transmit the non-priority signals to outside.

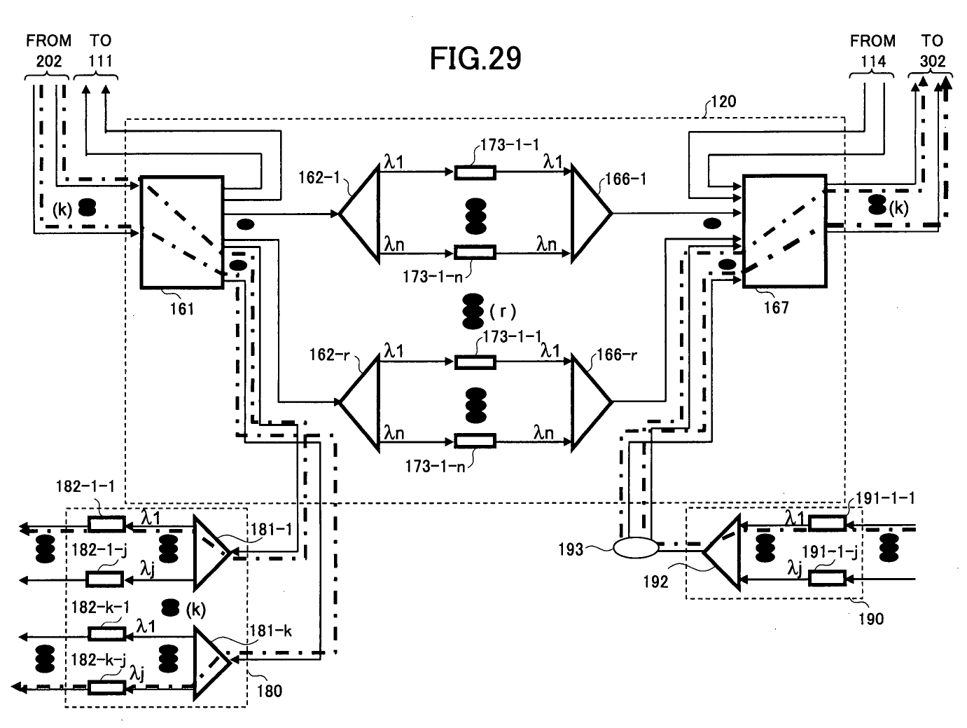

In FIG. 28, the optical multiplexers 192 in the PCA inputting section 190 are provided to have exactly the same number as the preliminary optical fibers 302 so as to be in correspondence to the preliminary optical fibers 302. Or, as illustrated in FIG. 29, one optical multiplexer 192 may be provided, and an optical distributor (DIS) 193 may be further provided to distribute the optical signals from the optical multiplexer 192 and output signals to the optical switch 167.

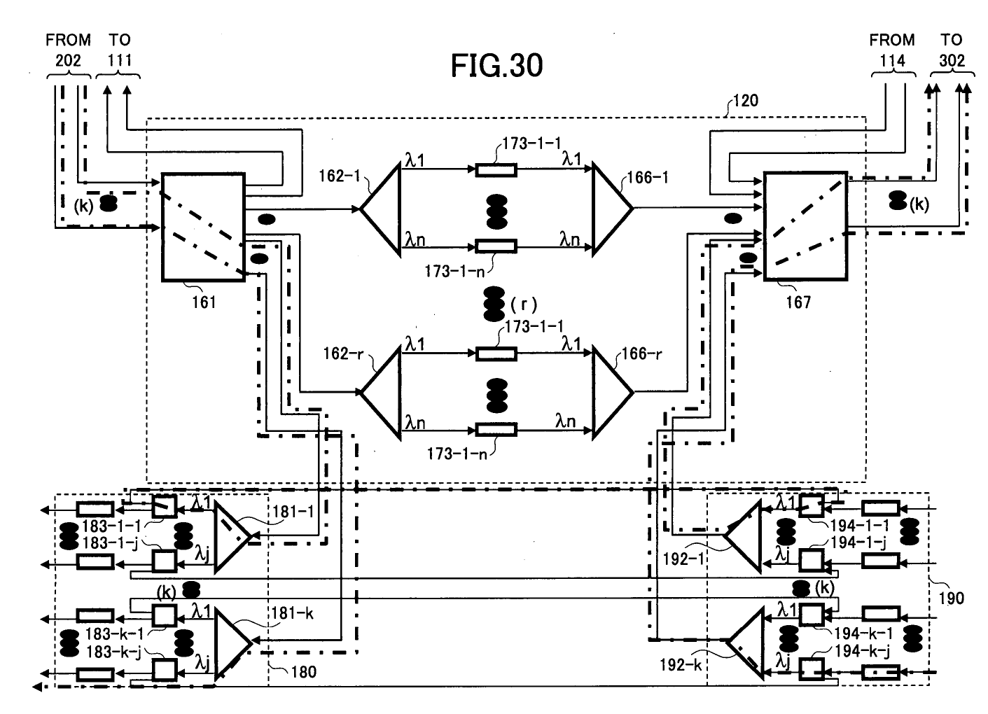

Alternatively, as illustrated in FIG. 30, in addition to providing an optical branch (BRA) 183 between one optical de-multiplexer 181 and the O/E/O 182 in the PCA outputting section 180, an optical selector 194 may be provided between one optical multiplexer 192 and the O/E/O 191 in the PCA inputting section 190, and the optical branch (BRA) 183 and the optical selector 194 may be connected. In this case, when a transmission path from a transmission node to a reception node is on normal conditions, the non-priority signals input from the preliminary optical fibers 202 and output to the preliminary optical fibers 302, namely, the non-priority signals need not be contained inside, are transmitted through the optical branch 183 to the optical selector 194.

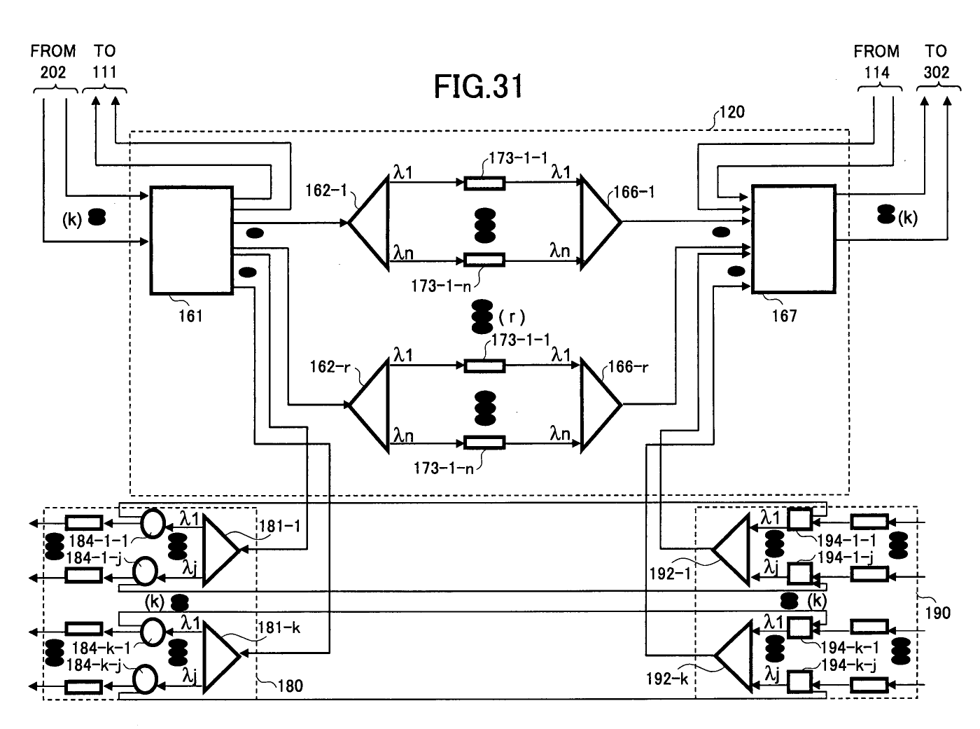

Further, as illustrated in FIG. 31, an optical distributor (DIS) 184 may be provided instead of the optical branch (BRA) 183.

According to the present invention, when the transmission path is operating under normal conditions, the optical cross-connect device switches and transmits not only the priority signals but also the non-priority signals, and this enables efficient utilization of the bandwidth. On the other hand, when the transmission path is in trouble, the optical cross-connect device switches and transmits only the priority signals; hence, it is possible to preferentially transmit the priority signals even though the bandwidth is reduced due to the trouble. In other words, according to the present invention, it is possible to execute optical communication control corresponding to transmission priority, specifically, it is possible to preferentially transmit signals of higher transmission priority when trouble occurs in a transmission path.

While the invention has been described with reference to preferred embodiments, the invention is not limited to these embodiments, but numerous modifications could be made thereto without departing from the basic concept and scope described in the claims.

1. An optical cross-connect device provided in an optical network that is constituted by a pair of a presently-used optical fiber and a preliminary optical fiber to transmit priority signals and non-priority signals having different priority levels from a transmission node to a reception node, said optical cross-connect device comprising:
a switching unit that,
when a transmission path from a transmission node to a reception node is operating under normal conditions, switches the priority signals from the presently-used optical fiber at an input side and from inside, outputs the priority signals to the presently-used optical fiber at an output side and to the inside, switches the non-priority signals from the preliminary optical fiber at the input side and from the inside, and outputs the non-priority signals to the preliminary optical fiber at the output side and to the inside, and
when the transmission path from the transmission node to the reception node is in trouble, switches the priority signals from the preliminary optical fiber at the input side and from the inside, and outputs the priority signals to the preliminary optical fiber at the output side and to the inside.

2. The optical cross-connect device as claimed in claim 1, wherein
the switching unit comprises:
a first optical switch that, when the transmission path from the transmission node to the reception node is operating under normal conditions, switches the priority signals from the presently-used optical fiber at the input side and from the inside, and outputs the priority signals to the presently-used optical fiber at the output side and to the inside; and
a second optical switch that, when the transmission path from the transmission node to the reception node is operating under normal conditions, switches the non-priority signals from the preliminary optical fiber at the input side and from the inside, outputs the non-priority signals to the preliminary optical fiber at the output side and to the inside, and when the transmission path from the transmission node to the reception node is in trouble, switches the priority signals from the preliminary optical fiber at the input side and from the inside, and outputs the priority signals to the preliminary optical fiber at the output side and to the inside,
wherein
when the transmission path from the transmission node to the reception node is operating under normal conditions, the switching unit switches the priority signals from the presently-used optical fiber at the input side and from the inside, outputs the priority signals to the presently-used optical fiber at the output side and to the inside, switches the non-priority signals from the preliminary optical fiber at the input side and from the inside, and outputs the non-priority signals to the preliminary optical fiber at the output side and to the inside, and
when the transmission path from the transmission node to the reception node is in trouble, the switching unit switches the priority signals from the preliminary optical fiber at the input side and from the inside, and outputs the priority signals to the preliminary optical fiber at the output side and to the inside.

3. An optical cross-connect device provided in an optical network that is constituted by an optical fiber having a presently-used wavelength band and a preliminary wavelength band to transmit priority signals and non-priority signals having different priority levels from a transmission node to a reception node, said optical cross-connect device comprising:
a switching unit that,
when a transmission path from a transmission node to a reception node is operating under normal conditions, switches the priority signals from the presently-used wavelength band of the optical fiber at an input side and from inside, outputs the priority signals to the presently-used wavelength band of the optical fiber at an output side and to the inside, switches the non-priority signals from the preliminary wavelength band of the optical fiber at the input side and from the inside, and outputs the non-priority signals to the preliminary wavelength band of the optical fiber at the output side and to the inside, and
when the transmission path from the transmission node to the reception node is in trouble, switches the priority signals from the preliminary wavelength band of the optical fiber at the input side and from the inside, and outputs the priority signals to the preliminary wavelength band of the optical fiber at the output side and to the inside.

4. The optical cross-connect device as claimed in claim 3, wherein
the switching unit comprises:
a first optical switch that, when the transmission path from the transmission node to the reception node is operating under normal conditions, switches the priority signals from the presently-used wavelength band of the optical fiber at the input side and from the inside, and outputs the priority signals to the presently-used wavelength band of the optical fiber at the output side and to the inside; and
a second optical switch that, when the transmission path from the transmission node to the reception node is operating under normal conditions, switches the non-priority signals from the preliminary wavelength band of the optical fiber at the input side and from the inside, outputs the non-priority signals to the preliminary wavelength band of the optical fiber at the output side and to the inside, and when the transmission path from the transmission node to the reception node is in trouble, switches the priority signals from the preliminary wavelength band of the optical fiber at the input side and from the inside, and outputs the priority signals to the preliminary wavelength band of the optical fiber at the output side and to the inside,
wherein
when the transmission path from the transmission node to the reception node is operating under normal conditions, the switching unit switches the priority signals from the presently-used wavelength band of the optical fiber at the input side and from the inside, outputs the priority signals to the presently-used wavelength band of the optical fiber at the output side and to the inside, switches the non-priority signals from the preliminary wavelength band of the optical fiber at the input side and from the inside, and outputs the non-priority signals to the preliminary wavelength band of the optical fiber at the output side and to the inside, and
when the transmission path from the transmission node to the reception node is in trouble, the switching unit switches the priority signals from the preliminary wavelength band of the optical fiber at the input side and from the inside, and outputs the priority signals to the preliminary wavelength band of the optical fiber at the output side and to the inside.

5. The optical cross-connect device as claimed in claim 4, further comprising:
a first path conversion unit that, when the transmission path from the transmission node to the reception node is operating under normal conditions, outputs the priority signals from an priority signal inner connection line at the input side to the first optical switch, outputs the non-priority signals from a non-priority signal inner connection line at the input side to the second optical switch, and when the transmission path from the transmission node to the reception node is in trouble, outputs the priority signals from the priority signal inner connection line at the input side to the second optical switch; and
a second path conversion unit that, when the transmission path from the transmission node to the reception node is operating under normal conditions, outputs the priority signals switched by the first optical switch to the priority signal inner connection line at the output side, outputs the non-priority signals switched by the second optical switch to the non-priority signal inner connection line at the output side, and when the transmission path from the transmission node to the reception node is in trouble, outputs the priority signals switched by the second optical switch to the priority signal inner connection line at the output side.

6. The optical cross-connect device as claimed in claim 5, wherein
the first path conversion unit comprises:
a first optical branching unit that outputs an optical signal from an input end thereof to one of a plurality of output ends thereof; and
a first optical selection unit that outputs one of optical signals from a plurality of input ends thereof to an output end thereof;
wherein
the input end of the first optical branching unit is connected to the priority signal inner connection line at the input side, and the output ends of the first optical branching unit are connected to the first optical switch and the input end of the first optical branching unit;
the first optical branching unit, when the transmission path from the transmission node to the reception node is operating under normal conditions, outputs the priority signals from the priority signal inner connection line at the input side to the first optical switch, and when the transmission path from the transmission node to the reception node is in trouble, outputs the priority signals from the priority signal inner connection line at the input side to the first optical selection unit;
the input ends of the first optical selection unit are connected to the output end of the first optical branching unit and the non-priority signal inner connection line at the input side, and the output end of the first optical selection unit is connected to the second optical switch; and
the first optical selection unit, when the transmission path from the transmission node to the reception node is operating under normal conditions, outputs the non-priority signals from the non-priority signal inner connection line at the input side to the second optical switch, and when the transmission path from the transmission node to the reception node is in trouble, outputs the priority signals from the first optical selection unit to the second optical switch.

7. The optical cross-connect device as claimed in claim 6, which further comprises, instead of the first optical branching unit, a first optical distribution unit that outputs an optical signal from an input end thereof to all of a plurality of output ends thereof.

8. The optical cross-connect device as claimed in claim 5, wherein
the second path conversion unit comprises:
a second optical branching unit that outputs an optical signal from an input end thereof to one of a plurality of output ends thereof; and
a second optical selection unit that outputs one of optical signals from a plurality of input ends thereof to an output end thereof;
wherein
the input end of the second optical branching unit is connected to the second optical switch, and the output ends of the second optical branching unit is connected to the non-priority signal inner connection line at the output side and to the input end of the second optical selection unit;
the second optical branching unit, when the transmission path from the transmission node to the reception node is operating under normal conditions, outputs the non-priority signals from the second optical branching unit to the non-priority signal inner connection line at the output side, and when the transmission path from the transmission node to the reception node is in trouble, outputs the non-priority signals from the second optical branching unit to the second optical selection unit;
the input ends of the second optical selection unit are connected to the first optical switch and the output end of the second optical branching unit, and the output end of the second optical selection unit is connected to the priority signal inner connection line at the output side; and
the second optical selection unit, when the transmission path from the transmission node to the reception node is operating under normal conditions, outputs the priority signals from the first optical switch to the priority signal inner connection line at the output side, and when the transmission path from the transmission node to the reception node is in trouble, outputs the priority signals from the second optical branching unit to the priority signal inner connection line at the output side.

9. The optical cross-connect device as claimed in claim 8, which further comprises, instead of the second optical branching unit, a second optical distribution unit that outputs an optical signal from an input end thereof to all of a plurality of output ends thereof.

10. An optical cross-connect device provided in an optical network that is constituted by a pair of a presently-used optical fiber and a preliminary optical fiber to transmit priority signals and non-priority signals having different priority levels from a transmission node to a reception node, said optical cross-connect device comprising:
a switching unit that,
when a transmission path from a transmission node to a reception node is operating under normal conditions, switches the priority signals from the presently-used optical fiber at an input side and from inside, outputs the priority signals to the presently-used optical fiber at an output side and to the inside, switches the non-priority signals from the preliminary optical fiber at the input side and from the inside, and outputs the non-priority signals to the preliminary optical fiber at the output side and to the inside, and
when the transmission path from the transmission node to the reception node is in trouble, switches the priority signals from a preliminary optical fiber at the input side in a transmission path bypassing a trouble spot and from the inside, and outputs the priority signals to a preliminary optical fiber at the output side in the transmission path bypassing the trouble spot and to the inside.

11. The optical cross-connect device as claimed in claim 10, wherein
the switching unit comprises:
a first optical switch that, when the transmission path from the transmission node to the reception node is operating under normal conditions, switches the priority signals from the presently-used optical fiber at the input side and from the inside, outputs the priority signals to the presently-used optical fiber at the output side and to the inside, and when the transmission path from the transmission node to the reception node is in trouble, switches the priority signals from the preliminary optical fiber at the input side in the transmission path bypassing the trouble spot and from the inside, and outputs the priority signals to the preliminary optical fiber at the output side in the transmission path bypassing the trouble spot and to the inside; and
a second optical switch that, when the transmission path from the transmission node to the reception node is operating under normal conditions, switches the non-priority signals from the preliminary optical fiber at the input side and from the inside, and outputs the non-priority signals to the preliminary optical fiber at the output side and to the inside,
wherein
when the transmission path from the transmission node to the reception node is operating under normal conditions, the switching unit switches the priority signals from the presently-used optical fiber at the input side and from the inside, outputs the priority signals to the presently-used optical fiber at the output side and to the inside, switches the non-priority signals from the preliminary optical fiber at the input side and from the inside, and outputs the non-priority signals to the preliminary optical fiber at the output side and to the inside, and
when the transmission path from the transmission node to the reception node is in trouble, the switching unit switches the priority signals from the preliminary optical fiber at the input side in the transmission path bypassing the trouble spot and from the inside, and outputs the priority signals to the preliminary optical fiber at the output side in the transmission path bypassing the trouble spot and to the inside.

12. The optical cross-connect device as claimed in claim 11, further comprising:
a first path conversion unit that, when the transmission path from the transmission node to the reception node is operating under normal conditions, outputs the non-priority signals from the preliminary optical fiber at the input side to the second optical switch, and when the transmission path from the transmission node to the reception node is in trouble, outputs the priority signals from the preliminary optical fiber at the input side in the transmission path bypassing the trouble spot to the first optical switch; and
a second path conversion unit that, when the transmission path from the transmission node to the reception node is operating under normal conditions, outputs the non-priority signals from the second optical switch to the preliminary optical fiber at the output side, and when the transmission path from the transmission node to the reception node is in trouble, outputs the priority signals from the first optical switch to the preliminary optical fiber at the output side in the transmission path bypassing the trouble spot.

13. The optical cross-connect device as claimed in claim 12, wherein the second optical switch is provided for each of a plurality of de-multiplexed optical signals from the first path conversion unit.

14. The optical cross-connect device as claimed in claim 12, wherein the second optical switch receives all of a plurality of de-multiplexed optical signals from the first path conversion unit.

15. The optical cross-connect device as claimed in claim 12, wherein
the second optical switch comprises:
an optical-electrical conversion unit that converts the optical signals from the first path conversion unit into electrical signals;
an electrical switch that switches the electrical signals from the optical-electrical conversion unit; and
an electrical-optical conversion unit that converts the electrical signals from the electrical switch into optical signals.

16. The optical cross-connect device as claimed in claim 11, further comprising:
a first non-priority signal output unit that outputs the non-priority signals from the second optical switch to the inside; and
a second non-priority signal output unit that outputs the non-priority signals from the inside to the second optical switch.

17. The optical cross-connect device as claimed in claim 16, wherein
the second non-priority signal output unit comprises:
an optical multiplexing unit that multiplexes the non-priority signals from the inside corresponding to the preliminary optical fiber at the output side, and outputs the resulting signals to the second optical switch.

18. The optical cross-connect device as claimed in claim 16, wherein
the second non-priority signal output unit comprises:
an optical multiplexing unit that multiplexes the non-priority signals from the inside; and
an optical distribution unit that outputs the non-priority signals from the optical multiplexing unit to the second optical switch through all the output ends thereof.

19. The optical cross-connect device as claimed in claim 16, wherein
the first non-priority signal output unit comprises an optical branching unit that outputs the non-priority signals from the second optical switch to the inside or to the second non-priority signal output unit; and
the second non-priority signal output unit comprises an optical selection unit that outputs one of the non-priority signals from the inside or from the second non-priority signal output unit to the second optical switch.

20. The optical cross-connect device as claimed in claim 19, which further comprises, instead of the optical branching unit, an optical distribution unit that outputs the non-priority signals from the second optical switch to both the inside and the second non-priority signal output unit.

21. An optical communication control method for an optical cross-connect device which is provided in an optical network constituted by a pair of a presently-used optical fiber and a preliminary optical fiber to transmit priority signals and non-priority signals having different priority levels from a transmission node to a reception node, and includes a presently-used section and a preliminary section, said optical communication control method comprising the steps of:
when a transmission path from a transmission node to a reception node is operating under normal conditions, switching the priority signals from the presently-used optical fiber at an input side and from inside, outputting the priority signals to the presently-used optical fiber at an output side and to the inside, switching the non-priority signals from the preliminary optical fiber at the input side and from the inside, and outputting the non-priority signals to the preliminary optical fiber at the output side and to the inside, and
when the transmission path from the transmission node to the reception node is in trouble, switching the priority signals from the preliminary optical fiber at the input side and from the inside, and outputting the priority signals to the preliminary optical fiber at the output side and to the inside.

22. An optical communication control method for an optical cross-connect device which is provided in an optical network that is constituted by an optical fiber having a presently-used wavelength band and a preliminary wavelength band to transmit priority signals and non-priority signals having different priority levels from a transmission node to a reception node, and includes a presently-used section and a preliminary section, said optical communication control method comprising the steps of:
when a transmission path from a transmission node to a reception node is operating under normal conditions, switching the priority signals from the presently-used wavelength band of the optical fiber at an input side and from inside, outputting the priority signals to the presently-used wavelength band of the optical fiber at an output side and to the inside, switching the non-priority signals from the preliminary wavelength band of the optical fiber at the input side and from the inside, and outputting the non-priority signals to the preliminary wavelength band of the optical fiber at the output side and to the inside, and
when the transmission path from the transmission node to the reception node is in trouble, switching the priority signals from the preliminary wavelength band of the optical fiber at the input side and from the inside, and outputting the priority signals to the preliminary wavelength band of the optical fiber at the output side and to the inside.

23. An optical communication control method for an optical cross-connect device which is provided in an optical network constituted by a pair of a presently-used optical fiber and a preliminary optical fiber to transmit priority signals and non-priority signals having different priority levels from a transmission node to a reception node, and includes a presently-used section and a preliminary section, said optical communication control method comprising the steps of:
when a transmission path from a transmission node to a reception node is operating under normal conditions, switching the priority signals from the presently-used optical fiber at an input side and from inside, outputting the priority signals to the presently-used optical fiber at an output side and to the inside, switching the non-priority signals from the preliminary optical fiber at the input side and from the inside, and outputting the non-priority signals to the preliminary optical fiber at the output side and to the inside; and
when the transmission path from the transmission node to the reception node is in trouble, switching the priority signals from a preliminary optical fiber at the input side in a transmission path bypassing a trouble spot and from the inside, and outputting the priority signals to a preliminary optical fiber at the output side in the transmission path bypassing the trouble spot and to the inside.
